(19) United States
(12) Patent Application Publication
(10) Pub. No.: US 2025/0310724 A1
(43) Pub. Date: Oct. 2, 2025

(54) COHERENT CARRIER AGGREGATION FOR POSITIONING

(71) Applicant: QUALCOMM Incorporated, San Diego, CA (US)

(72) Inventors: Danlu ZHANG, San Diego, CA (US); Alexandros MANOLAKOS, Athens (GR); Arnold Jason GUM, San Diego, CA (US); Charles Edward WHEATLEY, Del Mar, CA (US); Robert GILMORE, Poway, CA (US); Mustafa KESKIN, San Diego, CA (US)

(21) Appl. No.: 18/873,156

(22) PCT Filed: Jun. 28, 2023
(86) PCT No.: PCT/US2023/026494

§ 371 Date: Dec. 9, 2024

(30) Foreign Application Priority Data
Jul. 28, 2022 (GR) 20220100611

(51) Int. Cl. H04W 4/029; H04L 5/00; H04W 36/00

(52) U.S. Cl. CPC H04W 4/029; H04L 5/0092; H04L 5/0098; H04W 36/00692

(57) ABSTRACT

Aspects presented herein may improve the accuracy and performance for a UE positioning by enabling positioning entities to apply carrier aggregation to transmission of positioning reference signals. In one aspect, a UE receives a first indication of CGPA, where the CGPA is associated with one or more transmission properties that include at least one of: a phase slope parameter, a phase offset parameter, an amplitude offset, a maximum timing coherency, or a transmission time difference. The UE receives a second indication of an association between a set of RSs and one or more CGPAs, where the association maps each of the set of RSs to one of the one or more CGPAs. The UE performs a set of positioning measurements for the set of RSs based on the association between the set of RSs and the one or more CGPAs.

### CROSS-REFERENCE TO RELATED APPLICATION

This application claims the benefit of Greece application No. 20220100611, entitled “COHERENT CARRIER AGGREGATION FOR POSITIONING” and filed on Jul. 28, 2022, which is expressly incorporated by reference herein in its entirety.

### TECHNICAL FIELD

The present disclosure relates generally to positioning systems, and more particularly, to positioning systems involving carrier aggregation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives a first indication of coherent group positioning aggregation (CGPA), where the CGPA is associated with one or more transmission properties that include at least one of: a phase slope parameter, a phase offset parameter, an amplitude offset, a maximum timing coherency, or a transmission time difference. The apparatus receives a second indication of an association between a set of reference signals (RSs) and one or more CGPAs, where the association maps each of the set of RSs to one of the one or more CGs. The apparatus performs a set of positioning measurements for the set of RSs based on the association between the set of RSs and the one or more CGPAs.

In an aspect of the disclosure, a method, a computer-readable medium, and an apparatus are provided. The apparatus receives a first indication of CGPA, where the CGPA is associated with one or more transmission properties that include at least one of: a phase slope parameter, a phase offset parameter, an amplitude offset, a maximum timing coherency, or a transmission time difference. The apparatus transmits a second indication of an association between a set of RSs and one or more CGPAs, where the association maps each of the set of RSs to one of the one or more CGPAs. The apparatus transmits a set of RSs based on the association between the set of RSs and the one or more CGPAs.

In an aspect of the disclosure, a method, a computer-readable medium, and an apparatus are provided. The apparatus transmits a first indication of CGPA, where the CGPA is associated with one or more transmission properties that include at least one of: a phase slope parameter, a phase offset parameter, an amplitude offset, a maximum timing coherency, or a transmission time difference. The apparatus transmits or receives a second indication of an association between a set of RSs and one or more CGPAs, where the association maps each of the set of RSs to one of the one or more CGPAs. The apparatus transmits or receives the set of RSs based on the association between the set of RSs and the one or more CGPAs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example carrier aggregation transmitter architecture in accordance with various aspects of the present disclosure.

FIG. 6 is a diagram illustrating an example carrier aggregation transmitter architecture in accordance with various aspects of the present disclosure.

FIG. 7 is a diagram illustrating an example carrier aggregation transmitter architecture in accordance with various aspects of the present disclosure.

FIG. 8 is a diagram illustrating an example carrier aggregation transmitter architecture in accordance with various aspects of the present disclosure.

FIG. 9 is a diagram illustrating an example coherent carrier aggregation transmitter architecture in accordance with various aspects of the present disclosure.

FIG. 10 is a diagram illustrating an example coherent carrier aggregation receiver architecture in accordance with various aspects of the present disclosure.

FIG. 11 is a diagram illustrating an example coherent carrier aggregation of positioning reference signals over different time and frequency resources in accordance with various aspects of the present disclosure.

FIG. 12 is a diagram illustrating example elements of a coherent group positioning aggregation (CGPA) in accordance with various aspects of the present disclosure.

FIG. 13 is a communication flow illustrating an example signaling scheme for downlink positioning aggregation in accordance with various aspects of the present disclosure.

FIG. 14 is a communication flow illustrating an example signaling scheme for uplink positioning aggregation in accordance with various aspects of the present disclosure.

FIG. 15 is a communication flow illustrating an example signaling scheme for sidelink positioning aggregation in accordance with various aspects of the present disclosure.

FIG. 16 is a flowchart of a method of wireless communication.

FIG. 17 is a flowchart of a method of wireless communication.

FIG. 18 is a diagram illustrating an example of a hardware implementation for an example apparatus and/or network entity.

FIG. 19 is a flowchart of a method of wireless communication.

FIG. 20 is a flowchart of a method of wireless communication.

FIG. 21 is a diagram illustrating an example of a hardware implementation for an example apparatus and/or network entity.

FIG. 22 is a flowchart of a method of wireless communication.

FIG. 23 is a flowchart of a method of wireless communication.

FIG. 24 is a diagram illustrating an example of a hardware implementation for an example apparatus and/or network entity.

### DETAILED DESCRIPTION

Aspects presented herein may improve the accuracy and performance for a UE positioning by enabling positioning entities associated with the UE positioning (e.g., the UE, base stations, TRPs, etc.) to apply carrier aggregation (CA) to transmission of positioning reference signals (e.g., DL-PRS, UL-SRS, and/or sidelink reference signal (SL RS), etc.), such that the positioning reference signals may be transmitted using wider bands/bandwidths. Aspects presented herein also provide a variety of signaling schemes to enable the use of composite waveform across component carriers (CCs) on both DL, UL, and SL transmissions. Aspects presented herein also provide RF architectures that may enable the phase alignment specified for a composite waveform. Certain baseband processing mechanisms associated with the composite waveform are also provided to ensure the gain from composite waveform.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

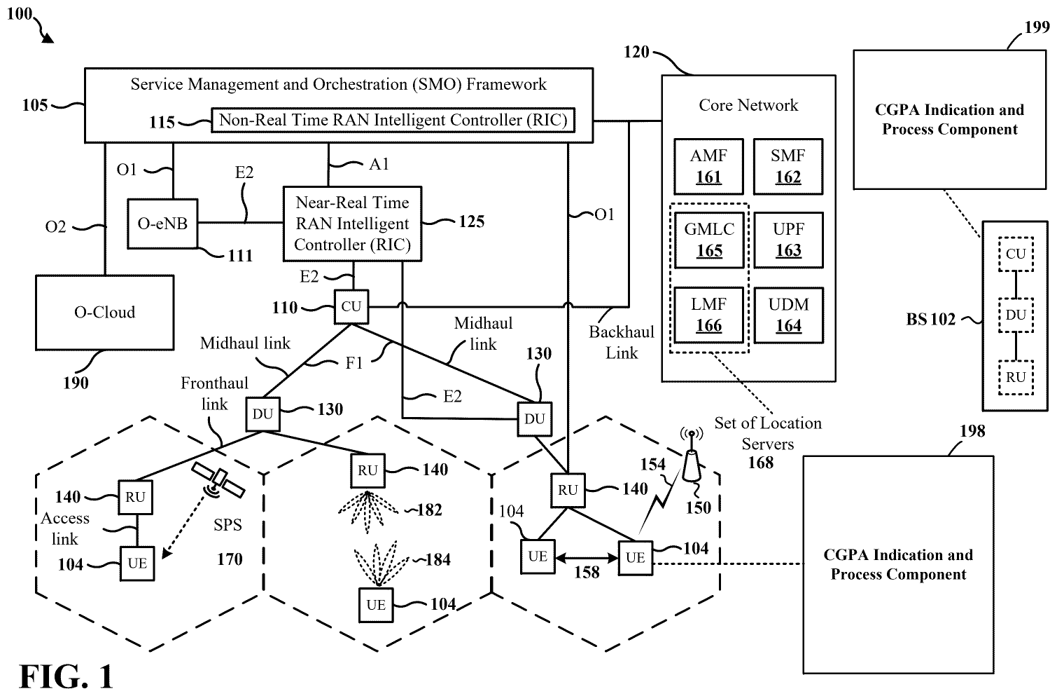

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RA configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to receive a first indication of CGPA, where the CGPA is associated with one or more transmission properties that include at least one of: a phase slope parameter, a phase offset parameter, an amplitude offset, a maximum timing coherency, or a transmission time difference; receive a second indication of an association between a set of RSs and one or more CGPAs, where the association maps each of the set of RSs to one of the one or more CGPAs; and perform a set of positioning measurements for the set of RSs based on the association between the set of RSs and the one or more CGPAs (e.g., via the CGPA indication and process component 198). In certain aspects, the UE 104 may be configured to receive a first indication of CGPA, where the CGPA is associated with one or more transmission properties that include at least one of: a phase slope parameter, a phase offset parameter, an amplitude offset, a maximum timing coherency, or a transmission time difference; transmit a second indication of an association between a set of RSs and one or more CGPAs, where the association maps each of the set of RSs to one of the one or more CGPAs; and transmit a set of RSs based on the association between the set of RSs and the one or more CGPAs (e.g., via the CGPA indication and process component 198). In certain aspects, the base station 102 may be configured to transmit a first indication of CGPA, where the CGPA is associated with one or more transmission properties that include at least one of: a phase slope parameter, a phase offset parameter, an amplitude offset, a maximum timing coherency, or a transmission time difference; transmit or receive a second indication of an association between a set of RSs and one or more CGPAs, where the association maps each of the set of RSs to one of the one or more CGPAs; and transmit or receive the set of RSs based on the association between the set of RSs and the one or more CGPAs (e.g., via the CGPA indication and process component 199).

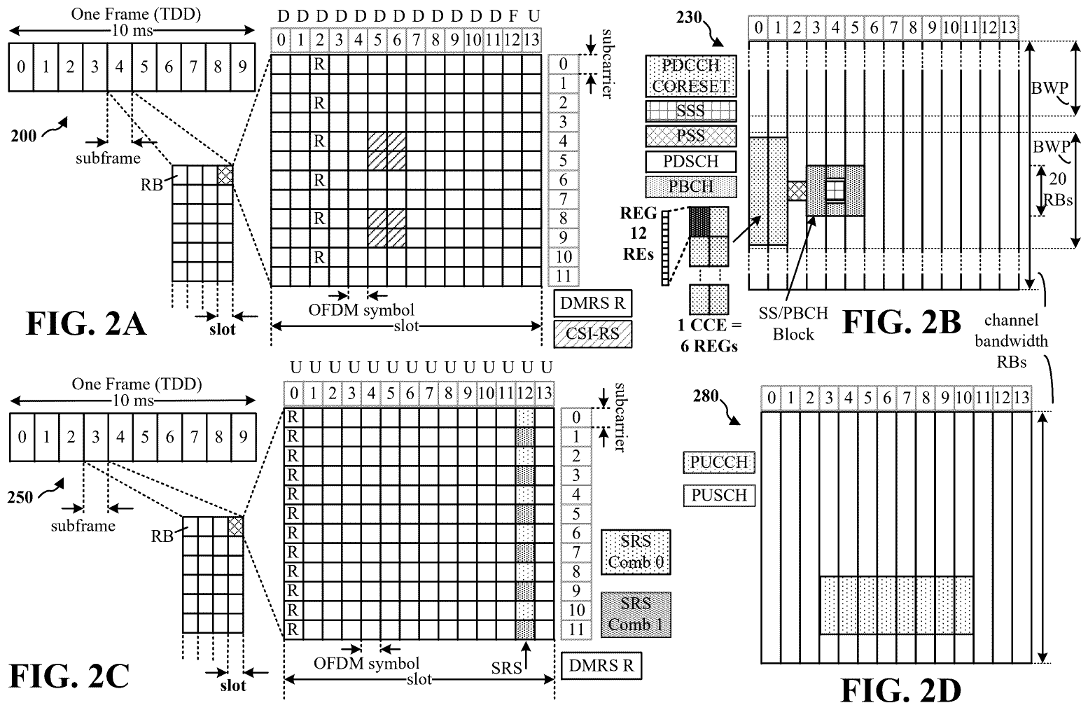

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

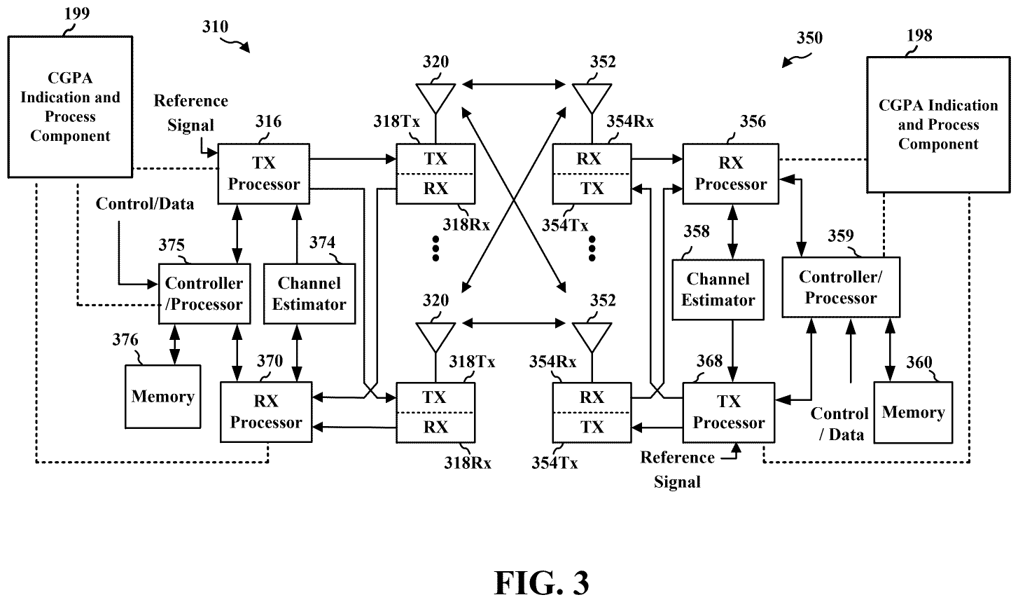

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CGPA indication and process component 198 of FIG. 1.

At least one of the TX processor 316, the RX processor 370, and the controller/processor 375 may be configured to perform aspects in connection with the CGPA indication and process component 199 of FIG. 1.

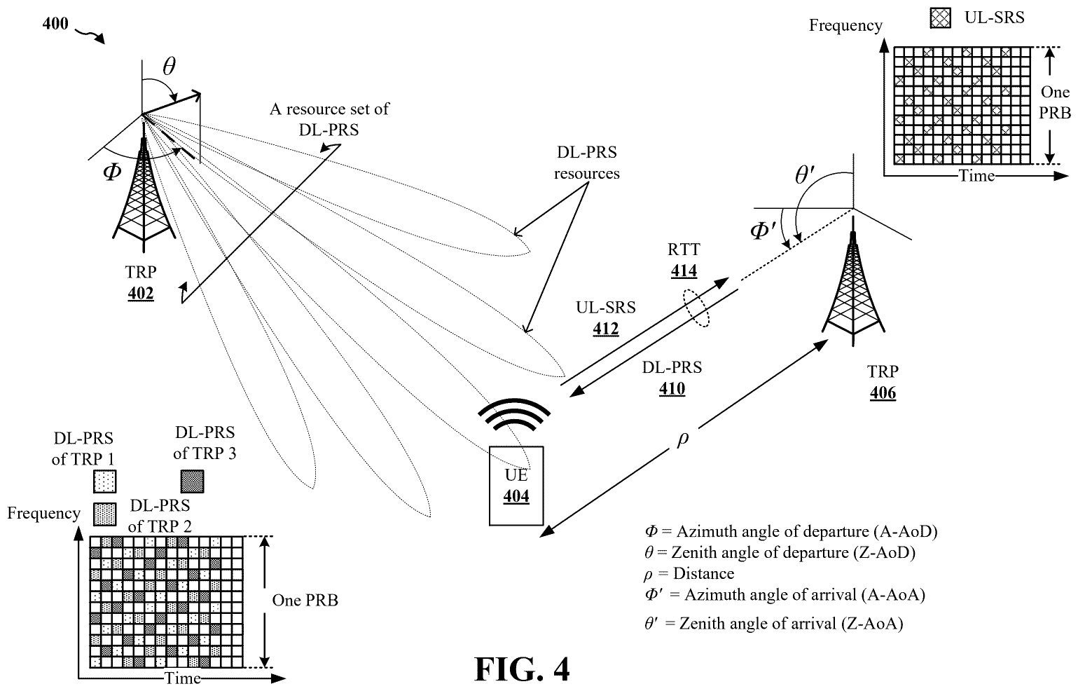

FIG. 4 is a diagram 400 illustrating an example of a UE positioning based on reference signal measurements (which may also be referred to as “network-based positioning”) in accordance with various aspects of the present disclosure. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}-T_{PRS_TX}|-|T_{SRS_TX}-T_{PRS_RX}∥. Accordingly, multi-RTT positioning may make use of the UE Rx-Tx time difference measurements (i.e., |T_{SRS_TX}-T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}-T_{PRS_TX}|) and UL-SRS-RSRP at multiple TRPs 402, 406 of uplink signals transmitted from UE 404. The UE 404 measures the UE Rx-Tx time difference measurements (and/or DL-PRS-RSRP of the received signals) using assistance data received from the positioning server, and the TRPs 402, 406 measure the gNB Rx-Tx time difference measurements (and/or UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL-PRS-RSRP) of downlink signals received from multiple TRPs 402, 406 at the UE 404. The UE 404 measures the DL RSTD (and/or DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL-SRS-RSRP) at multiple TRPs 402, 406 of uplink signals transmitted from UE 404. The TRPs 402, 406 measure the UL-RTOA (and/or UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information. For purposes of the present disclosure, the suffixes “-based” and “-assisted” may refer respectively to the node that is responsible for making the positioning calculation (and which may also provide measurements) and a node that provides measurements (but which may not make the positioning calculation). For example, an operation in which measurements are provided by a UE to a base station/positioning entity to be used in the computation of a position estimate may be described as “UE-assisted,” “UE-assisted positioning,” and/or “UE-assisted position calculation” while an operation in which a UE computes its own position may be described as “UE-based,” “UE-based positioning,” and/or “UE-based position calculation.”

Aspects presented herein may improve the accuracy and performance for a UE positioning by enabling positioning entities associated with the UE positioning (e.g., the UE, base stations, TRPs, etc.) to apply carrier aggregation (CA) to transmission of positioning reference signals (e.g., DL-PRS, UL-SRS, and/or sidelink reference signal (SL RS), etc.), such that the positioning reference signals may be transmitted using wider bands/bandwidths.

In some scenarios, a more accurate distance and/or timing estimation for a UE positioning may be obtained when wider signals (e.g., reference signals with higher/broader bandwidth) are used compared to narrower signals (e.g., reference signals with lower/narrower bandwidth). For example, a UE positioning session using reference signals with 200 MHz bandwidth may achieve a higher positioning accuracy compared to a UE positioning session using reference signals with 20 MHz bandwidth.

Carrier aggregation is a technique that is used in wireless communication to increase the data rate per user, whereby multiple component carriers (CCs) may be assigned to the same user. As such, carrier aggregation may provide a wider bandwidth than each component carrier. Thus, if carrier aggregation is able to be applied to a UE positioning to increase the bandwidth of positioning signals, a more accurate timing and/or distance estimation for the UE positioning may be realized, such as by estimating distance and/or timing from each component carrier and then averaging the estimates (or taking the earlier timing between the two). Also, further improvement may be achieved for the UE positioning if a composite waveform can be used for a searcher/cross-correlation operation associated with the carrier aggregation (e.g., waveforms across different CCs can be combined or aligned on a physical layer).

However, applying carrier aggregation to the UE positioning (or to positioning signals) may specify phase coherence across the CCs and the receiver (e.g., an entity that is receiving the positioning reference signals) is aware of the phase coherence. In some examples, phase coherence may be achieved with a common local oscillator (LO) (e.g., an electronic oscillator used with a mixer to change the frequency of a signal) and a phase-locked loop (PLL) (e.g., a feedback control system that automatically adjusts the phase of a locally generated signal to match the phase of an input signal) across multiple CCs, where signaling from a transmitter (e.g., an entity that is transmitting the positioning reference signals) may be specified for receiver awareness.

Aspects presented herein provide a variety of signaling schemes to enable the use of composite waveform across CCs on both DL, UL, and SL transmissions. Aspects presented herein also provide RF architectures that may enable the phase alignment specified for a composite waveform. Certain baseband processing mechanisms associated with the composite waveform are also provided to ensure the gain from composite waveform.

In one aspect, assume a positioning reference signal (e.g., PRS, SRS, or SL RS) using a sequence of {cₖ} is received by a receiver (e.g., a UE, a base station, etc.), with p(t) as the shape of pulse-shaping filter, τ as the timing offset and residual frequency error, and multi-path and multiple positioning reference signal sources are ignored, the timing estimation of the positioning reference signal may be determined based on:

$$r ( t ) = {ae}^{j ( 2 π f t + φ ) t} {\sum }_{k = - ∞}^{∞} {c}_{k} p ( t - τ - {kT}_{c} ) + N ( t )$$

In some examples, the sequence of {cₖ} may be directly placed in the frequency domain (e.g., in an OFDM system), and then transformed to the time domain. For receiver searcher/cross-correlation processing using correlation duration T_{corr}=N_{corr}T_{c}, for each of hypothesis of the timing offset τ′:

$$\begin{matrix}A ( {τ}^{′} ) = {\int }_{0}^{{T}_{corr}} r ( t ) {e}^{- j 2 π f t} ( {\sum }_{{k}^{′} = 0}^{{N}_{corr} - 1} {c}_{{k}^{′}}^{*} {p}^{*} ( t - {τ}^{′} - {k}^{′} {T}_{c} ) ) dt \\ = {\int }_{0}^{{T}_{corr}} ( {ae}^{j φ} {\sum }_{k = - ∞}^{∞} {c}_{k} p ( t - τ - k {T}_{c} ) + N ( t ) ) \\ ( {\sum }_{{k}^{′} = 0}^{{N}_{corr} - 1} {c}_{{k}^{′}}^{*} {p}^{*} ( t - {τ}^{′} - {k}^{′} {T}_{c} ) ) dt\end{matrix}$$

The randomness of positioning reference signal sequence of {cₖ} implies when k′≠k, E(cₖc*_{k′})=0:

$$E [ A ( {τ}^{′} ) ] = a {e}^{j φ} E [ {\sum }_{{k}^{′} = 0}^{{N}_{corr - 1}} {\int }_{0}^{{T}_{corr}} p ( t - τ - {k}^{′} {T}_{c} ) {p}^{*} ( t - {τ}^{′} - {k}^{′} {T}_{c} ) dt ]$$

To determine the accuracy of the timing estimation, when τ<<T_{c}, E[A]≈αe^{jφ}N_{corr}Rₚ(τ-τ′), with Rₚ(τ-τ′)=∫p(t-τ)p*(t-τ′)dt as the correlation function of the pulse. Generally speaking, Rₚ(T′) is maximum at τ′=0, so

$$\frac{d {R}_{p} ( {τ}^{′} )}{d {τ}^{′}} = 0$$

when τ′=0; the decrease in Rₚ(τ′) around τ′=0 is determined by

$$\frac{d {R}_{p} ( {τ}^{′} )}{d {τ}^{′2}} .$$

E[A(τ′)] may be the key term for analysis on the accuracy.

In one example, assuming τ=0, then timing accuracy may largely dependent on αe

$${j φ}^{} {N}_{corr} \frac{{d}^{2} {R}_{p} ( τ′ )}{d {τ}^{′2}} ,$$

or considering noise,

$$\sqrt{{N}_{corr} * SNR} \vert \frac{{d}^{2} {R}_{p} ( τ′ )}{d {τ}^{′2}} \vert .$$

The above may achieve the accuracy of a faction of chip duration T_{c}, where higher processing gain N_{corr} may be beneficial and sharper

$$\frac{{d}^{2} {R}_{p} ( τ′ )}{d {τ}^{′2}}$$

may also beneficial (e.g., this may come from a narrower Rₚ(τ′) in time). As such, much better timing and/or distance estimation may be obtained by utilizing the carrier phase φ. In some scenarios, a separate method may be specified to overcome the ambiguity of multiple 2π in the phase estimate.

The above analysis implies that, with an integration length of N_{corr}, \hat{τ}, the estimate of τ′, has a variance of

$$VAR {( \hat{τ} )}_{1 C} = \frac{1}{{{N}_{corr} * SNR {\vert \frac{{d}^{2} {R}_{p} ( {τ}^{′} )}{d {τ}^{′2}} \vert}_{{τ}^{′} = 0} \vert}^{2}}$$

The Cramer-Rao (CR) lower bound (CRLB) may provide a lower estimate for the variance of an unbiased estimator. The CRLB of unbiased estimator \hat{τ} is:

$$\begin{matrix}VAR {( \hat{τ} )}_{1 C} = \frac{1}{{N}_{corr} * SNR * MSB} , MSB ( mean Square Bandwith ) \\ = \frac{\int {ω}^{2} {\vert {R}_{p} ( ω ) \vert}^{2} d ω}{\int {\vert {R}_{p} ( ω ) \vert}^{2} d ω}\end{matrix}$$

These two may show the same trend in the analysis below. From either formula, with two (2) carriers but independent timing estimation.

$$VAR {( \hat{τ} )}_{2 C , ind} = \frac{1}{2 {N}_{corr} * SNR * MSB} = \frac{VAR {( \hat{τ} )}_{1 C}}{2} .$$

With two (2) carriers and joint timing estimation:

$$VAR {( \hat{τ} )}_{2 C , joint} = \frac{1}{{N}_{corr} * SNR * 4 MSB} = \frac{VAR {( \hat{τ} )}_{1 C}}{4} .$$

The gain from coherent waveform may be seen. In some examples, taking the minimum of the two timing estimates may not be bounded by CRLB due to the bias, but similar results may still be achieved. In one aspect, two CCs may be aggregated with phase alignment when the chip timing offset τ is common for both CCs and carrier phase φ₁ and φ₂ are stable for a duration of at least T_{corr}. In one example, the received signal may be modeled as the following:

$$r ( t ) = {a}_{1} {e}^{j ( 2 π {f}_{1} t + {φ}_{1} )} {\sum }_{k = - ∞}^{∞} {c}_{1 , k} p ( t - τ - {kT}_{c} ) + {a}_{2} {e}^{j ( 2 π {f}_{2} t + {φ}_{2} )} {\sum }_{k = - ∞}^{∞} {c}_{2 , k} p ( t - τ - {kT}_{c} ) + N ( t )$$

r(t) may be jointly processed for f₁ and f₂ by a receiver together based on:

$$A = {\int }_{0}^{{T}_{corr}} r ( t ) ( {e}^{- j ( 2 π {f}_{1} t + {φ}_{1} )} {\sum }_{k = - 0}^{{N}_{corr} - 1} {c}_{1 , k}^{*} {p}^{*} ( t - {kT}_{c} ) + {e}^{- j ( 2 π {f}_{2} t + {φ}_{2} )} {\sum }_{k = - ∞}^{{N}_{corr} - 1} {c}_{2 , k}^{*} {p}^{*} ( t - {kT}_{c} ) dt$$

This may assume that α₁=α₂, which may be true if two carriers are close in frequency and each carrier is wide enough to average out frequency-selective fading (without this assumption, the processing mechanism is discussed below). The common t is unknown and is specified to be estimated. φ₁ and φ₂ are both known to the receiver. If φ₁ and φ₂ are not both known, they may be specified to be stable for a duration of the correlation time (corresponding processing is discussed below). For gain of using composite waveform, not just E[A]≈α(2N_{corr}) Rₚ(τ), but also a sharper Rₚ(τ) as a function of τ. This comparison may be similar to the one between coherent combining and non-coherent combining in demodulation.

In one example, a separate receiver processing may be applied for each carrier first:

$$\begin{matrix}{A}_{1} ( {τ}^{′} ) = {\int }_{0}^{{T}_{corr}} r ( t ) ( {e}^{- j 2 π {f}_{1} t} {\sum }_{k ′ = 0}^{{N}_{corr} - 1} {c}_{1 , k ′}^{*} {p}^{*} ( t - {τ}^{′} - {k}^{′} {T}_{c} ) ) dt \\ \approx {\int }_{0}^{{T}_{corr}} ( {a}_{1} {e}^{j {φ}_{1}} {\sum }_{k = - ∞}^{∞} {c}_{k} p ( t - τ - {kT}_{c} ) ) \\ ( {\sum }_{k ′ = 0}^{{N}_{corr} - 1} {c}_{k ′}^{*} {p}^{*} ( t - {τ}^{′} - {k}^{′} {T}_{c} ) ) dt \\ \approx {a}_{1} {e}^{j {φ}_{1}} {N}_{corr} {R}_{p} ( τ - {τ}^{′} )\end{matrix}$$

$$Likewise ,$$

$$\begin{matrix}{A}_{2} ( {τ}^{′} ) = {\int }_{0}^{{T}_{corr}} r ( t ) ( {e}^{- j 2 π {f}_{2} t} {\sum }_{k ′ = 0}^{{N}_{corr} - 1} {c}_{2 , k ′}^{*} {p}^{*} ( t - {τ}^{′} - {k}^{′} {T}_{c} ) ) dt \\ \approx {a}_{2} {e}^{j {φ}_{2}} {N}_{corr} {R}_{p} ( τ - {τ}^{′} )\end{matrix}$$

Without knowledge about relative transmitted signal strength and phase, a receiver may identify the best parameter estimates of α₁, α₂, φ₁, φ₂ and τ′, such that |A₁(τ′)+A₂(τ′)| may be maximized. In some examples, the knowledge of relative strength and phase may be used to constrain the above identification. In both situations, the calculation may achieve the gain of sharper Rₚ(τ) with less signaling.

In some network implementations, PRS resources may be configured across multiple frequency layers, which may reside in multiple bandwidth parts (BWPs) in the same CC, or in multiple CCs that may be contiguous, non-contiguous but in the same band, or in different bands. In some examples, there may be existing specifications on the timing errors among the multiple frequency layers. For example, for multiple frequency layers in multiple BWPs in the same CC, it may be assumed that the phase coherence is on the DL but not on the UL. For multiple BWPs across multiple CCs, the timing specification may be very loose and not useful in terms of phase coherence. For example, the tightest time adjustment error (e.g., for BS type 2-O) may be 130 nanoseconds (ns) for contiguous carrier aggregation, 260 ns for non-contiguous intra-band carrier aggregation, and/or 3 microseconds (μs) for inter-band carrier aggregation, etc. These specifications may be primarily driven by physical and MAC processing for data communications where the processing per CC may be independent. In some examples, the presence of phase noise, such as at higher frequencies (e.g., GHz bands and mmWave), a receiver may not be able to assume phase coherence across different CCs. Accordingly, aspects presented herein may show that phase coherence across BWPs and CCs is feasible, where a variety of signaling may be used to enable the use of a composite waveform to achieve the phase coherence.

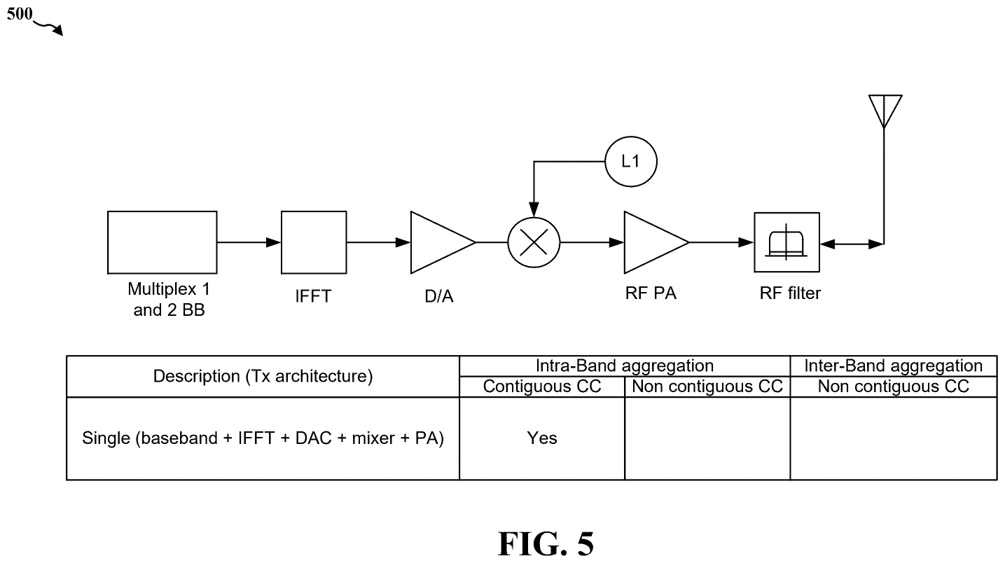

FIG. 5 is a diagram 500 illustrating an example carrier aggregation transmitter architecture in accordance with various aspects of the present disclosure. In one example, a transmitter (e.g., a UE) may have one power amplifier (PA) that is connected to a single radio frequency (RF) chain, where the RF chain may include a baseband processor, an Inverse Fast Fourier Transform (IFFT) module (e.g., a wideband IFFT which computes the discrete inverse fast Fourier transform of a variable), a digital-to-analog converter (DAC) (e.g., a wideband DAC), a mixer (e.g., a zero-IF mixer), and a radio frequency (RF) power amplifier (PA). Under such configuration, the transmitter may perform carrier aggregation for intra-band contiguous CCs.

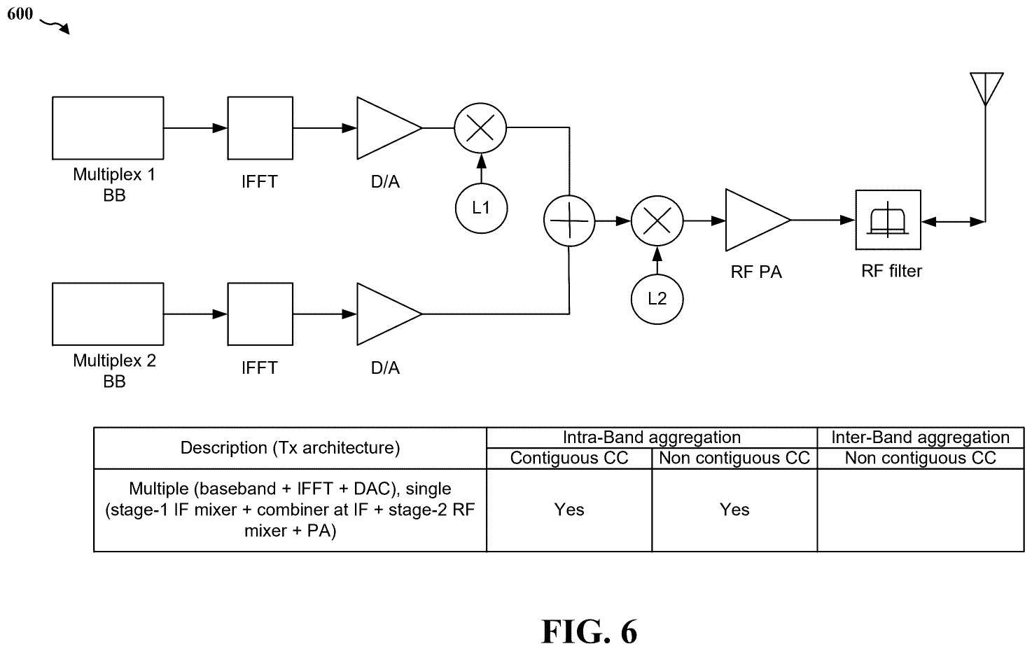

FIG. 6 is a diagram 600 illustrating an example carrier aggregation transmitter architecture in accordance with various aspects of the present disclosure. In another example, a transmitter may have one power amplifier (PA) and two IFFT modules, after which the transmitter combines analog baseband waveforms from the CCs (e.g., via a mixer operating at an intermediate frequency (IF) of roughly the bandwidth of the other component carrier). Then the resulting wideband signal is up-converted to RF. Under such configuration, the transmitter may perform carrier aggregation for both intra-band contiguous CCs and non-contiguous CCs.

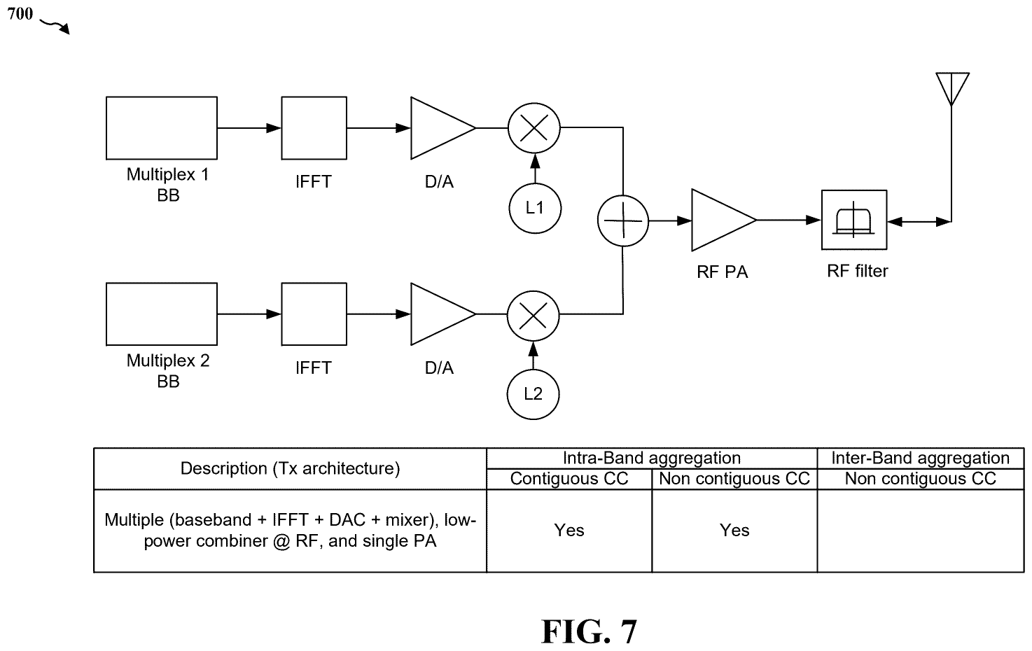

FIG. 7 is a diagram 700 illustrating an example carrier aggregation transmitter architecture in accordance with various aspects of the present disclosure. In another example, a transmitter may be configured to perform zero intermediate frequency (ZIF) up-conversion (e.g., no intermediate stage of RF conversion between baseband and RF band) of each CC before combining and feeding into a single PA. Under such configuration, the transmitter may also perform carrier aggregation for both intra-band contiguous CCs and non-contiguous CCs.

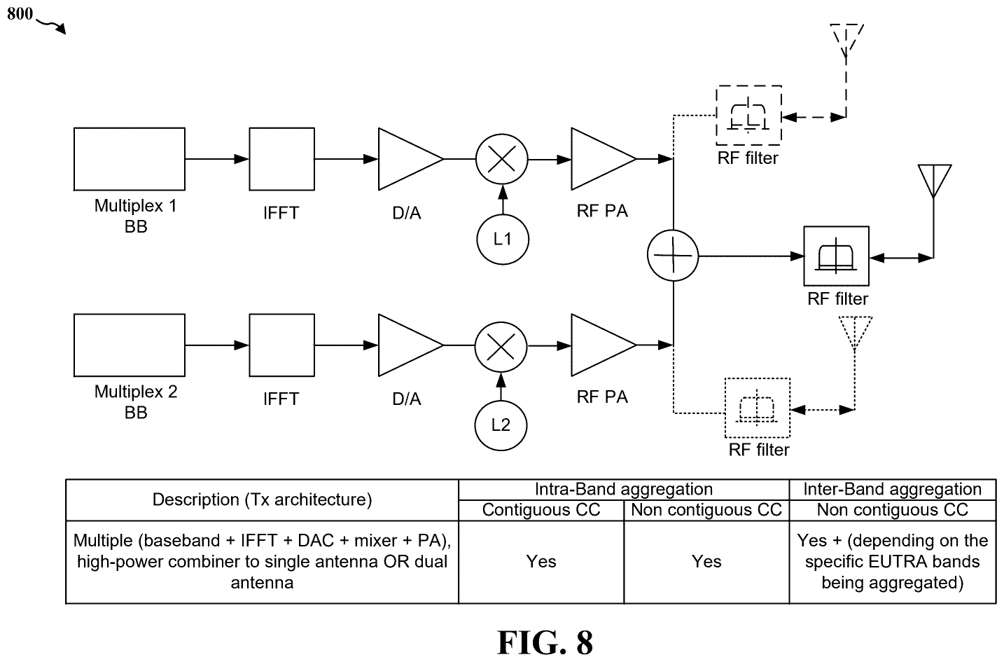

FIG. 8 is a diagram 800 illustrating an example carrier aggregation transmitter architecture in accordance with various aspects of the present disclosure. In another example, a transmitter may employ multiple RF chains and multiple PAs after which the high-power signals are combined and fed into a single antenna. PA coupling at the transmitter may be challenging for this configuration. However, under such configuration, the transmitter may perform carrier aggregation for both intra-band contiguous CCs and non-contiguous CCs, and also for inter-band non-contiguous CCs

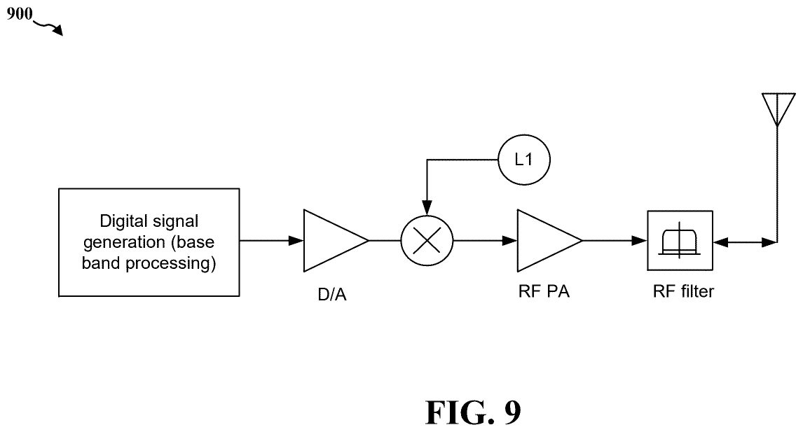

FIG. 9 is a diagram 900 illustrating an example coherent carrier aggregation transmitter architecture in accordance with various aspects of the present disclosure. For purposes of the present disclosure, coherence may refer to the properties of the interrelation between physical quantities of a single waveform or between multiple waveforms. For example, two waveforms may be coherent if they have a constant relative phase or if they have zero or constant phase difference and the same frequency.

In one example, architectures with a single local oscillator (LO) for multiple carriers/BWPs may be used to generate a composite waveform across them. For example, an extension of the carrier aggregation transmitter architecture described in connection with FIG. 5 may be configured by keeping all the parts from D/A (e.g., DAC) onward for the transmitter and replacing the specification of a single FFT with a relaxed condition of digital signal generation. The digital signal generation may be feasible for multiple BWPs by a base station. The digital signal generation may also be feasible for a UE for multiple BWPs or contiguous CCs. For non-contiguous intra-band CC, this architecture may still be feasible if the PLL and the oscillator is capable of handling the wide signal bandwidth.

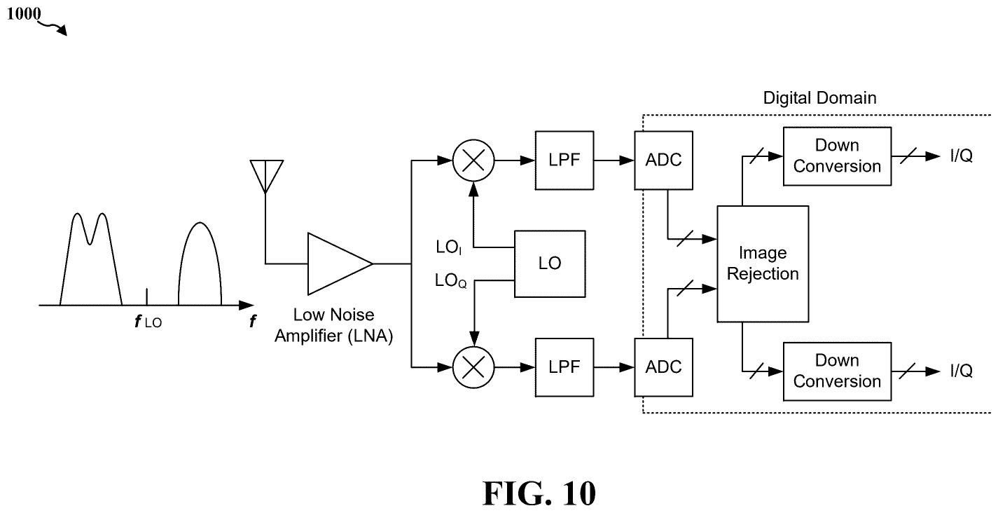

FIG. 10 is a diagram 1000 illustrating an example coherent carrier aggregation receiver architecture in accordance with various aspects of the present disclosure. While aspects described in connection with FIGS. 5 to 9 primarily focused on the transmitter side, there may be some similarities to the architecture of carrier aggregation receivers. For example, one key similarity is that there may be a single RF source for the multiple “carriers” (a single LO, for example). If multiple LOs are able to be phase aligned, this architecture may also be used for generating phase coherent waveforms.

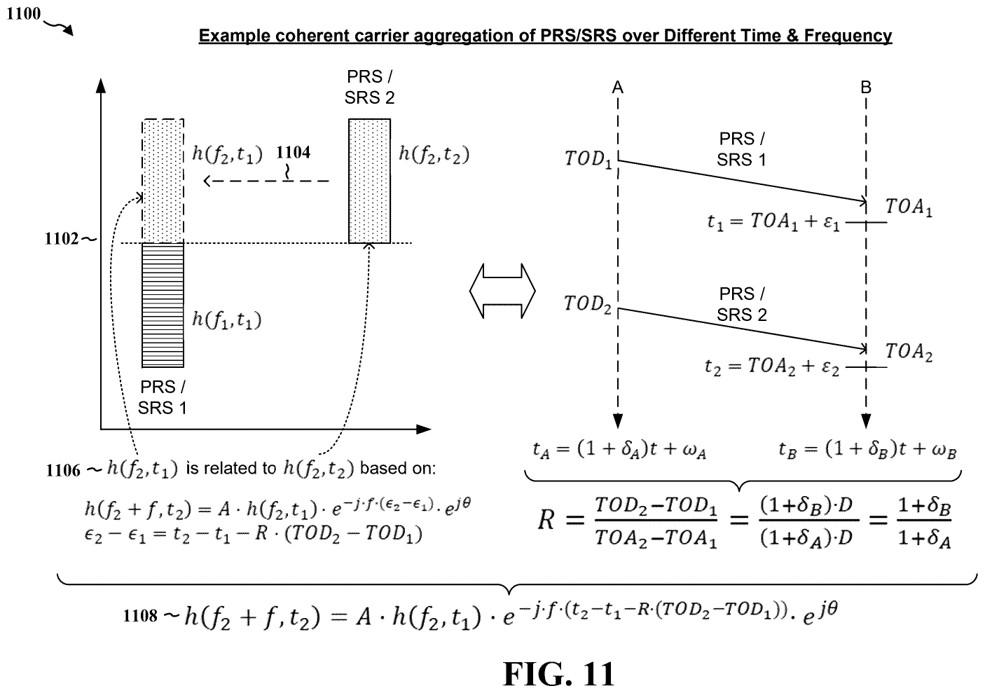

FIG. 11 is a diagram 1100 illustrating an example coherent carrier aggregation of positioning reference signals (e.g., PRS, SRS, SL RS, etc.) over different time and frequency resources in accordance with various aspects of the present disclosure. As shown at 1102, a transmitter (e.g., an entity A) may be configured to transmit, to a receiver (e.g., an entity B), a first reference signal (PRS/SRS/SL RS 1) based on a first time and frequency resource h(f₁, t₁) and a second reference signal (PRS/SRS/SL RS 2) based on a second time and frequency resource h(f₂, t₂). In one example, as shown at 1104, if the second time and frequency resource h(f₂, t₂) is shifted to align with the first time and frequency resource h(f₁, t₁) at h(f₂, t₁) (e.g., a frequency and time resource that overlaps with h(f₁, t₁) in time and h(f₂, t₂) in frequency), h(f₂, t₁) may be related to h(f₂, t₂) based on that the phase slope is a linear function of timestamps or time drift information (δ_{B}), the phase offset may depend on many factors, amplitude offset in case different PAs are used, and/or maximum timing coherency, etc. Thus, as shown at 1106, h(f₂, t₁) may be related to h(f₂, t₂) based on:

$$h ( {f}_{2} + f , {t}_{2} ) = A \cdot h ( {f}_{2} , {t}_{1} ) \cdot {e}^{- j \cdot f \cdot ( {ϵ}_{2} - {ϵ}_{1} )} \cdot {e}^{j θ} ,$$

$${ϵ}_{2} - {ϵ}_{1} = {t}_{2} - {t}_{1} - R \cdot ( {TOD}_{2} - {TOD}_{1} ) ,$$

$$where$$

$$R = \frac{{TOD}_{2} - {TOD}_{1}}{{TOA}_{2} - {TOA}_{1}} = \frac{( 1 + {δ}_{B} ) \cdot D}{( 1 + {δ}_{A} ) \cdot D} = \frac{1 + {δ}_{B}}{1 + {δ}_{A}} ,$$

such that, as shown at 1108,

$$h ( {f}_{2} + f , {t}_{2} ) = A \cdot h ( {f}_{2} , {t}_{1} ) \cdot {e}^{- j \cdot f \cdot ( {t}_{2} - {t}_{1} - R \cdot ( {TOD}_{2} - {TOD}_{1} ) )} \cdot {e}^{j θ} .$$

A UE may be configured with multiple frequency layers. In each frequency layer, there may be multiple transmission reception points (TRPs) where each TRP may have multiple resources. The phase coherence information may be conveyed to the UE (e.g., by a base station) in a variety of ways. For example, in one aspect of the present disclosure, for a TRP, if the phase is consistent across resources in each frequency layer, a network (e.g., a serving base station or a location server) may be specified to just signal the UE whether the TRP has different phase across layers. For example, the network may transmit this information to the UE in a list of Boolean indicators for each pair of frequency layers for the TRP and/or in a (n-1)-bit array for n frequency layers sorted from low frequency to high frequency, where the n-th bit is set to one (1) if the (n+1)-the layer is phase coherent with the n-th layer and set to zero (0) otherwise.

In another aspect of the present disclosure, for a TRP, if the phase changes across resources, a network may signal to the UE whether the TRP has different phase across different resources and layers. The network may deliver this information to the UE in one or multiple lists, where each list may summarize a group of frequency layer and resources in phase coherence. The set of lists may not be exhaustive. For example, if resource n of a first frequency layer (layer 1) and resource m of a second frequency layer (layer 2) are not in a list (e.g., a common list), the UE may consider them as not phase coherent.

In another aspect of a present disclosure, to enable coherent carrier aggregation for positioning (e.g., between multiple Tx/Rx positioning entities), a coherent (or coherency) group positioning aggregation (CGPA), or simply a coherent/coherency group (CG) may be defined for a positioning aggregation layer which is associated with a CG identifier (ID) (CG-ID), such that, one or more PRS resources, PRS resource sets, positioning frequency layers (PFLs) (e.g., in UL, DL, or SL) may be characterized/parameterized by the one or more properties between two positioning time and frequency resources (e.g., PRSs, SRSs, SL RSs, etc.), such as described in connection with FIG. 11. For purposes of the present disclosure, a positioning frequency layer (PFL) (which may also be referred to as a “frequency layer”) may refer to a collection of one or more PRS resource sets across one or more TRPs that have the same values for certain parameters. Specifically, the collection of PRS resource sets may have a same subcarrier spacing and cyclic prefix (CP) type (e.g., meaning all numerologies supported for PDSCHs are also supported for PRS), the same value of the downlink PRS bandwidth, the same start PRB (and center frequency), and/or the same comb-size, etc. In some examples, a downlink PRS bandwidth may have a granularity of four PRBs, with a minimum of 24 PRBs and a maximum of 272 PRBs. In other examples, up to four frequency layers may be configured, and up to two PRS resource sets may be configured per TRP per frequency layer. In some examples, the concept of a frequency layer may be similar to a CC and a BWP, where CCs and BWPs may be used by one base station (or a macro cell base station and a small cell base station) to transmit data channels, while frequency layers may be used by multiple (e.g., two or more) base stations to transmit PRS. A UE may indicate the number of frequency layers it is capable of supporting when the UE sends the network its positioning capabilities, such as during a positioning protocol session. For example, a UE may indicate whether it is capable of supporting one or four PFLs.

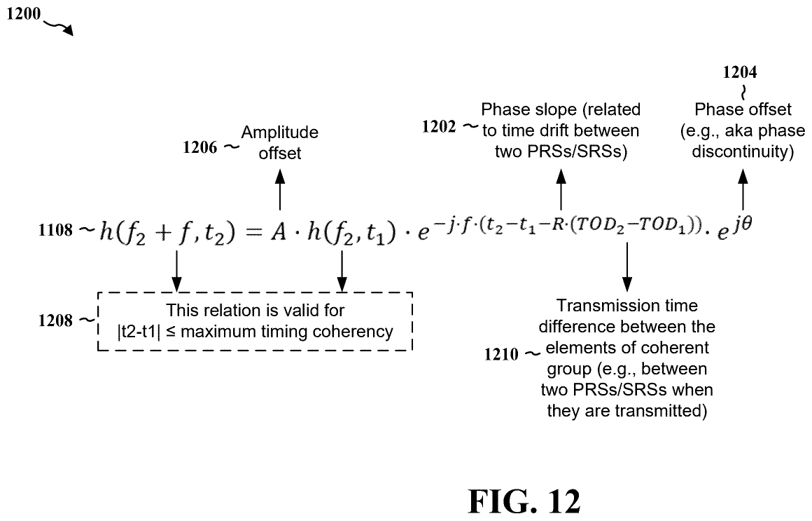

FIG. 12 is a diagram 1200 illustrating example elements of a CGPA/CG in accordance with various aspects of the present disclosure. If h₁ (e.g., channel for transmitting a first positioning signal) and h₂ (e.g., channel for transmitting a second positioning signal) are the channels/ports of reference signal resources (e.g., PRS/SRS/SL RS resources, PRS/SRS/SL RS resource sets, and/or PFLs, etc.) associated with the same CG (or the corresponding CG-ID), then the relation between h₁ and h₂ may be based on

$$h ( {f}_{2} + f , {t}_{2} ) = A \cdot h ( {f}_{2} , {t}_{1} ) \cdot {e}^{- j \cdot f \cdot ( {t}_{2} - {t}_{1} - R \cdot ( {TOD}_{2} - {TOD}_{1} ) )} \cdot {e}^{j θ}$$

(as discussed in connection with FIG. 11). For example, a CG for positioning aggregation layer that is associated with a CG-ID may include one or more PRS resources, PRS resource sets, PFLs (e.g., in UL, DL, or SL) that are associated with one or more transmission properties, such that a channel that can be inferred by one of the transmission properties (e.g., elements) of a CG may be related to any other transmission properties of the same CG as follows:
(1) a phase slope parameter (R) in the frequency domain (it may also be specified as a time drift parameter (δ_{B}) of the transmitter between two PRSs/SRSs), such as shown at 1202;
(2) a phase offset parameter (θ) which may be common across the frequency (and may also be known as phase discontinuity, such as shown at 1204;
(3) an amplitude offset (A), such as shown at 1206;
(4) a maximum timing coherency or time difference between the transmission times of the two (2) elements of the CG such that the above parameters (e.g., the phase slope, the phase offset, and/or the amplitude offset) is valid (e.g., |t₂-t₁|≥maximum timing coherency) as shown at 1208, and in some examples, the maximum timing coherency or time difference may also be used for integrity determination purposes;
(5) a transmission time difference (TOD₂-TOD₁), which may also be known as real time difference (RTD) between two PRS/SRS resources, such as shown at 1210; and/or
(6) standard deviation of one or more of the parameters (1) to (5), e.g., a plus and minus value for the phase slope, the phase offset, and/or the amplitude offset, etc. As such, for resources within the same CG or associated with the same CG-ID, they may be related to one another based on at least one of the above parameters. For example, when two PRSs are within the same CG, it may indicate that the second PRSs is transmitted with X amplitude offset, Y phase slope, and/or Z phase offset, etc. In another example, when the two SRSs are within the same CG, it may indicate that a constant value for the maximum timing coherency or transmission time difference is applied.

In some examples, the amplitude offset (3) may be frequency dependent, or valid in parts of a frequency band (e.g. not valid in the edge of the respective channels/frequency band). For example, the amplitude (A) may be configured to be dependent on the frequency (f₂) of the second PRS/SRS/SL RS, such that

$$h ( {f}_{2} + f , {t}_{2} ) = A ( {f}_{2} ) \cdot h ( {f}_{2} , {t}_{1} ) \cdot {e}^{- j \cdot f \cdot ( {t}_{2} - {t}_{1} - R \cdot ( {TOD}_{2} - {TOD}_{1} ) )} \cdot {e}^{j θ} ,$$

e.g. for different frequencies, different amplitudes are applied. In another example, the amplitude (A) may be configured to be valid on parts of the frequency and not valid in the edge of the respective channels. For example, an amplitude may be valid for a center eight (8) MHz of a frequency band, but not valid for frequencies outside of the eight MHz frequency band.

Similarly, in some examples, the phase offset (2) may also be frequency dependent or valid solely in parts of the frequency (e.g. not valid in the edge of the respective channels). For example, the phase offset (θ) may be configured to be dependent on the frequency (f₂) of the second PRS/SRS, such that

$$h ( {f}_{2} + f , {t}_{2} ) = A \cdot h ( {f}_{2} , {t}_{1} ) \cdot {e}^{- j \cdot f \cdot ( {t}_{2} - {t}_{1} - R \cdot ( {TOD}_{2} - {TOD}_{1} ) )} \cdot {e}^{j θ ( {f}_{2} )} , e . g . ,$$

for different frequencies, different phase offsets are applied. In another example, the phase offset may be configured to be valid on parts of the frequency and not valid in the edge of the respective channels. For example, a phase offset may be valid for a frequency band, but not valid for frequencies outside the frequency band.

As discussed above, to apply coherent carrier aggregation to UE positioning, a receiving entity may be specified to be aware of the coherence. Aspects presented herein provide some example signaling between a transmitting entity and a receiving entity during a UE positioning session. The transmitting entity may be an entity that transmits positioning reference signals, which may be a UE, a base station, or a sidelink device, and the receiving entity may be an entity that receives the positioning reference signals, which may also be a UE, a base station, or a sidelink device.

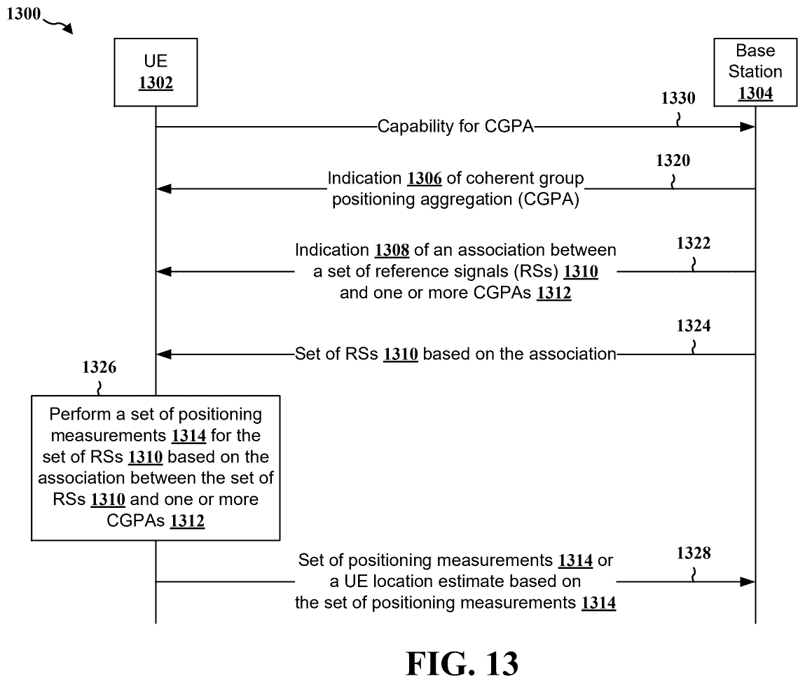

FIG. 13 is a communication flow 1300 illustrating an example signaling scheme for downlink positioning aggregation in accordance with various aspects of the present disclosure. The numberings associated with the communication flow 1300 do not specify a particular temporal order and are merely used as references for the communication flow 1300. Aspects presented herein may enable a base station to indicate coherent groups for positioning aggregation (CGPA) (which may also be simply referred to as coherent group (CG) in some examples) properties for a set of PRSs to a UE, such as described in connection with FIGS. 11 and 12. Multiple frequency layers may be mapped to multiple BWPs in the same CC, and/or in multiple CCs that may be contiguous, non-contiguous but in the same band, or in different bands. Within each CGPA, the multiple PRSs may be assumed to be transmitted in a way dictated by the properties of the CGPA, so that a composite waveform may be used for the UE during a UE positioning session.

At 1320, a base station 1304 may transmit an indication 1306 indicating CGPA properties to a UE 1302 (e.g., indicating that the base station 1304 supports downlink coherent carrier aggregation and/or CGPA properties supported by the base station 1304, etc.). The CGPA may be associated with one or more transmission properties and their standard deviations, such as described in connection with FIGS. 11 and 12. For example, the one or more transmission properties may include a phase slope parameter, a phase offset parameter, an amplitude offset, a maximum timing coherency, a transmission time difference, or a combination thereof. In addition, the amplitude offset or the phase offset parameter may be frequency dependent or may be valid for a defined frequency range.

At 1322, the base station 1304 may transmit, to the UE 1302, an indication 1308 indicating an association between a set of reference signals (RSs) 1310 (e.g., a set of PRSs) and one or more CGPAs 1312 (e.g., based on the indication 1306). For example, the association may map each of the set of RSs 1310 to one of the one or more CGPAs 1312. Each of the one or more CGPAs 1312 may be associated/assigned with a CG-ID, such that the base station 1304 may indicate the association based on the CG-ID. In addition, each of the one or more CGPAs 1312 may be associated with one or more PRS resources, one or more PRS resource sets, one or more PFLs, or a combination thereof. The set of RSs 1310 may correspond to a plurality of BWPs for a same component carrier CC, multiple contiguous CCs, or non-contiguous CCs in a same band, or the set of RSs 1310 may correspond to a plurality of BWPs for multiple CCs across different bands.

In some scenarios, some of the elements (e.g., transmission properties) of a CGPA may not be configurable, or reportable, but may be fixed. For example: if the base station 1304 configures a coherent transmission of two PRSs across two CCs, it may indicate that the amplitude offset is within X dB, the phase offset is within Y degrees, and/or the maximum time period within Z μs, etc.

At 1324, the base station 1304 may transmit the set of RSs 1310 based on the association between the set of RSs 1310 and the one or more CGPAs 1312, and the UE 1302 may receive the set of RSs 1310 based on the association between the set of RSs 1310 and the one or more CGPAs 1312 to achieve coherent carrier aggregation for DL positioning (which may also be referred to as DL positioning aggregation).

At 1326, after receiving the set of RSs 1310, the UE 1302 may perform a set of positioning measurements 1314 for the set of RSs 1310 based on the association between the set of RSs 1310 and the one or more CGPAs 1312. For example, as described in connection with FIG. 4, positioning measurements may include measuring DL-PRS-RSRP of downlink signals (e.g., for DL-AoD positioning), measuring RSTD of downlink signals (e.g., for DL-TDOA positioning), and/or measuring RTT of downlink signals (e.g., for RTT based positioning), etc.

At 1328, depending on whether the UE positioning is based on UE-based positioning or UE-assisted positioning, the UE 1302 may transmit the set of positioning measurements 1314 (e.g., for UE-assisted positioning) or a location of the UE 1302 estimated based on the set of positioning measurements 1314 (e.g., for UE-based positioning) to another entity, such as the base station 1304, a location server, an LMF, or to another UE, etc.

In one example, as shown at 1330, the UE 1302 may indicate one or more capabilities of the UE for the CGPA, such as to the base station 1304, a location server, an LMF or a second UE (e.g., for sidelink positioning). As such, the UE 1302 may receive the indication 1306 described in connection with 1320 based on the one or more capabilities indicated. In some examples, the one or more capabilities of the UE 1302 may be transmitted in a band of at least one band combination, or transmitted for each band pair combination of at least one band pair combination.

For example, the CGPA capabilities may be based on a band (e.g., frequency band) in a band combination, e.g., the CGPA depends on a band combination. A band combination may include a first band and a second band, where PRS transmitted in the first band is part of a first CGPA, and PRS transmitted in the second band is part of a second CGPA (or may also be part of the first CGPA). In another example, a band combination may include a second band and a third band, where PRS transmitted in the second band is part of a second CGPA, and PRS transmitted in the third band is part of a third CGPA, etc.

In another example, the one or more capabilities of the UE 1302 may be transmitted based on the UE meeting a minimum specification for supporting the CGPA. For example, minimum specifications may be introduced for the UE 1302 and/or the base station 1304 to report capability of supporting the CGPA. Such specifications may be in the form of a maximum phase offset error, a maximum phase slope error, a maximum timing difference error, a maximum amplitude offset error, a minimum timing difference coherency, or a combination thereof. In addition, parameters of the CGPA may be reset and/or reported periodically, such as for every slot, every frame, etc. In another example, an element of the CGPA may be designated as the anchor for phase, timing, and/or amplitude offset reference(s). For example, if there are four PRSs in the CGPA, one parameter in the first PRS may be used as the anchor for one or more parameters in the second, third, and fourth PRSs.

In another example, different level of specification may be configured for different configurations/settings. For example, the minimum specification for supporting the CGPA may be most stringent for two PRSs/SRSs on the same BWP, then two contiguous CCs, then non-contiguous CCs in the same band, then CCs inter-band, different frequency ranges (FRs), etc.

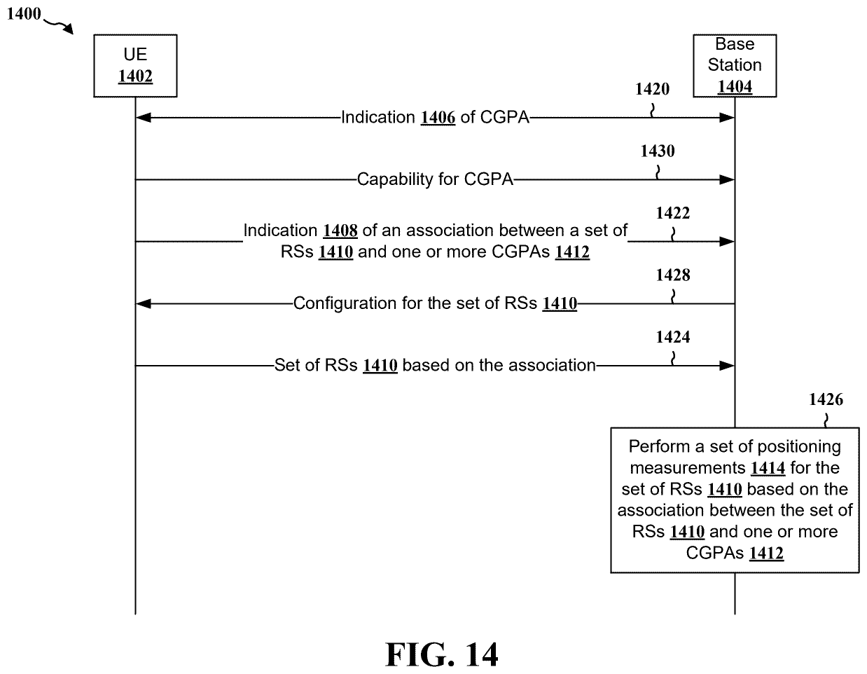

FIG. 14 is a communication flow 1400 illustrating an example signaling scheme for uplink positioning aggregation in accordance with various aspects of the present disclosure. The numberings associated with the communication flow 1400 do not specify a particular temporal order and are merely used as references for the communication flow 1400. Aspects presented herein may enable a UE to indicate its capability on CGPA properties, such as to a base station, a location server, an LMF, and/or another UE, etc. Similarly, within each CGPA, the SRSs may be assumed/configured to be transmitted in a way dictated by the properties of the CGPA, so that a composite waveform may be used for a receiving entity for positioning process.

At 1420, a base station 1404 may transmit an indication 1406 indicating CGPA properties to a UE 1402 (e.g., indicating that the base station 1404 supports uplink coherent carrier aggregation). The CGPA may be associated with one or more transmission properties and their standard deviations, such as described in connection with FIGS. 11 and 12. For example, the one or more transmission properties may include a phase slope parameter, a phase offset parameter, an amplitude offset, a maximum timing coherency, a transmission time difference, or a combination thereof. In addition, the amplitude offset or the phase offset parameter may be frequency dependent or may be valid for a defined frequency range. In some examples, the indication 1406 indicating the CGPA may be transmitted from the UE 1402 to the base station 1404 if the UE 1402 has such capability.

At 1430, prior to or after receiving the indication 1406, the UE 1402 may indicate one or more capabilities of the UE 1402 for the CGPA, such as to the base station 1404 (e.g., via RRC), a location server, an LMF (e.g., via LPP signaling), or a second UE (e.g., via sidelink reporting). As such, the UE 1402 may receive the indication 1406 described in connection with 1420 based on the one or more capabilities indicated.

In one example, the UE 1420 may send its CGPA capabilities as part of SRS for positioning capabilities towards the base station 1404. For example, the CGPA capabilities may be based on a band (e.g., frequency band) in a band combination, e.g., the CGPA depends on a band combination (two bands using the same PA may use the same CGPA). For example, a band combination may include a first band and a second band, where SRS transmitted in the first band is part of a first CGPA, and SRS transmitted in the second band is part of a second CGPA (or may also be part of the first CGPA). In another example, a band combination may include a second band and a third band, where SRS transmitted in the second band is part of a second CGPA, and SRS transmitted in the third band is part of a third CGPA, etc.

In another example, the CGPA capabilities may be based on a band pair combination. For example, two SRSs may be transmitted via a first band and a second band (e.g., one SRS per band) that are associated with the same CGPA. This may also indicate that the SRSs have the amplitude offset that is within X dB, the phase offset within Y degrees, the maximum time period within Z μs, etc.

In another aspect of the present disclosure, the UE 1402 may report separate CGPA capabilities for RRC connected state and RRC inactive state (e.g., for DL and/or UL positioning). For example, if the UE 1402 is transmitting SRSs in an RRC inactive state during a UE positioning session, the UE 1402 may not be able to support any CGPA. Thus, the network (e.g., the base station 1404) may be configured to assume that the SRSs transmitted from the UE 1402 during the RRC inactive state of the UE 1402 are not related with any of the ways that the CGPA framework would dictate. However, when the UE 1402 in RRC connected, the UE 1402 may be able to support the CGPA framework.

In another example, the UE 1402 may report separate CGPA capabilities for SRS for positioning outside active BWP. For example, for SRSs that are transmitted outside of an active BWP during a UE positioning session, a UE may not be able to support any coherency group. Thus, the network (e.g., the base station 1404) may be configured to assume that the SRSs transmitted from the UE 1402 that are outside of an active BWP are not related with any of the ways that the CGPA framework would dictate. However, if the SRSs are transmitted within the same active BWP, then the UE 1402 may be able to support the CGPA framework.

In another example, the capabilities for CGPA may be transmitted based on the UE 1402 meeting a minimum specification for supporting the CGPA. For example, minimum specifications may be introduced for the UE 1402 and/or the base station 1404 to report capability of supporting the CGPA. Such specifications may be in the form of a maximum phase offset error, a maximum phase slope error, a maximum timing difference error, a maximum amplitude offset error, a minimum timing difference coherency, or a combination thereof. In addition, parameters of the CGPA may be reset and/or reported periodically, such as for every slot, every frame, etc. In another example, an element of the CGPA may be designated as the anchor for phase, timing, and/or amplitude offset reference(s). For example, if there are four SRSs in the CGPA, one parameter in the first SRS may be used as the anchor for one or more parameters in the second, third, and fourth SRSs.

In another example, different level of specification may be configured for different configurations/settings. For example, the minimum specification for supporting the CGPA may be most stringent for two PRSs/SRSs on the same BWP, then two contiguous CCs, then non-contiguous CCs in the same band, then CCs inter-band, different frequency ranges (FRs), etc.

At 1422, the UE 1402 may transmit, to the base station 1404, an indication 1408 indicating an association between a set of RSs 1410 (e.g., a set of SRSs) and one or more CGPAs 1412 (e.g., based on the indication 1406). The association may map each of the set of RSs 1410 to one of the one or more CGPAs 1412. Each of the one or more CGPAs 1412 may be associated/assigned with a CG-ID, such that the UE 1402 may indicate the association based on the CG-ID. The set of RSs 1410 may correspond to a plurality of BWPs for a same component carrier CC, multiple contiguous CCs, or non-contiguous CCs in a same band, or the set of RSs 1410 may correspond to a plurality of BWPs for multiple CCs across different bands.

In one example, for UL-TDOA and/or UL-AoA based UE positioning, subject to the capability of the UE 1402, the base station 1404 (e.g., a serving base station) may request the UE 1402 to provide the association information of UL SRS resources for positioning with the corresponding Tx CG-ID to the base station 1404. Then, the base station 1404 may forward the association information provided by the UE 1402 to an LMF. In some scenarios, the base station 1404 may also be configured to forward the association information to one or more neighboring (or non-serving) base stations (e.g., other base stations that are participating with the UE positioning). In addition, the UE 1402 may also be configured to report its capability of supporting multiple UE Tx timing error groups (TEGs) for UL TDOA to the base station 1404.

In another example, for multi-RTT based UE positioning, subject to capability of the UE 1402, an LMF may request the UE 1402 to provide the association information of UL SRS resources for positioning with Tx CG-ID directly to the LMF. The LMF may forward the association information to the serving and neighboring base stations. The UE 1402 may also report its capability of supporting multiple UE CGPAs directly to the LMF.

In some scenarios, some of the elements (e.g., transmission properties) of a CGPA may not be configurable, or reportable, but may be fixed. For example: if the UE 1402 configures a coherent transmission of two SRSs across two CCs, it may indicate that the amplitude offset is within X dB, the phase offset is within Y degrees, and/or the maximum time period within Z μs, etc.

In one example, as shown at 1428, the base station 1404 may transmit a configuration for the set of RSs based on the association between the set of RSs and the one or more CGPAs.

At 1424, the UE 1402 may transmit the set of RSs 1410 based on the association between the set of RSs 1410 and the one or more CGPAs 1412 (and also based on the configuration if it is received at 1428), and the base station 1404 may also receive the set of RSs 1410 based on the association between the set of RSs 1410 and the one or more CGPAs 1412 to achieve coherent carrier aggregation for UL positioning (which may also be referred to as UL positioning aggregation).

At 1426, after receiving the set of RSs 1410, the base station 1404 may perform a set of positioning measurements 1414 for the set of RSs 1410 based on the association between the set of RSs 1410 and the one or more CGPAs 1412.

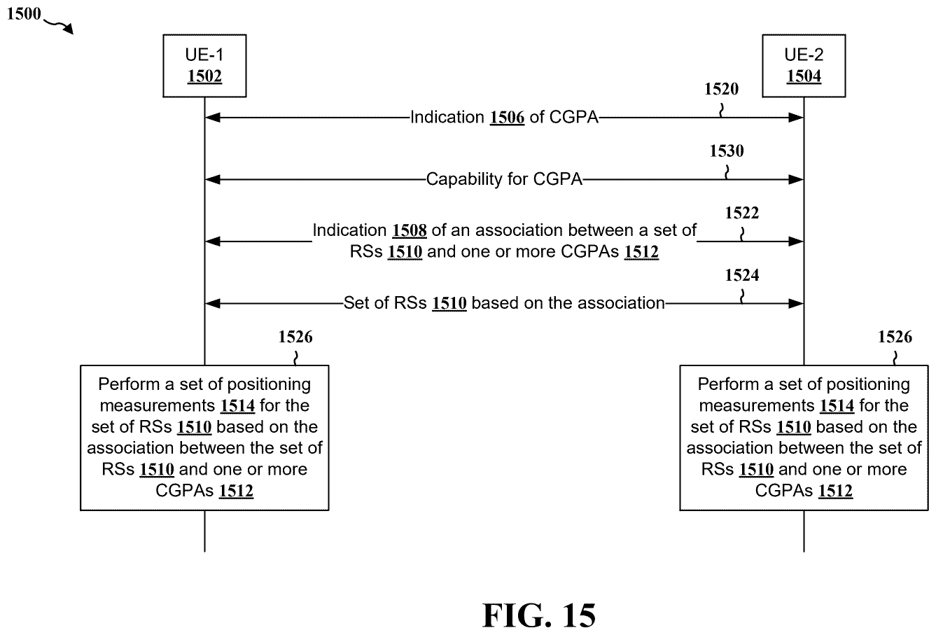

FIG. 15 is a communication flow 1500 illustrating an example signaling scheme for sidelink positioning aggregation in accordance with various aspects of the present disclosure. The numberings associated with the communication flow 1500 do not specify a particular temporal order and are merely used as references for the communication flow 1500. Aspects presented herein may enable a sidelink UE to indicate its capabilities on CGPA properties, such as to another sidelink UE during a sidelink positioning. Similarly, within each CGPA, the sidelink reference signals (SL RSs) are assumed to be transmitted in a way dictated by the properties of the CGPA, so that a composite waveform may be used for a receiving entity for positioning process.

At 1520, a first UE 1502 may transmit an indication 1506 indicating CGPA properties to a second UE 1504 (e.g., to indicate that the first UE 1502 supports sidelink coherent carrier aggregation). The CGPA may be associated with one or more transmission properties and their standard deviations, such as described in connection with FIGS. 11 and 12. For example, the one or more transmission properties may include a phase slope parameter (which may also be known as frequency domain drift rate in some examples), a phase offset parameter (which may also be known as frequency offset or phase offset ins some examples), an amplitude offset (which may also be known as energy per resource element (EPRE) offset in some examples), a maximum timing coherency, a transmission time difference (which may also be known as real time difference (RTD) in some examples), or a combination thereof. In addition, the amplitude offset or the phase offset parameter may be frequency dependent or may be valid for a defined frequency range. In some examples, the indication 1506 indicating the CGPA may be transmitted from the second UE 1504 to the first UE 1502 instead.

At 1530, prior to or after receiving the indication 1506, the first UE 1502 may indicate one or more capabilities of the UE 1502 for the CGPA to the second UE 1504 or vice versa, such as via sidelink reporting. As such, the UE 1502 may receive the indication 1506 described in connection with 1520 based on the one or more capabilities indicated.

In one example, the first UE 1502 may send its CGPA capabilities as part of SL RSs for positioning capabilities towards the first UE 1502. For example, the CGPA capabilities may be based on band (e.g., frequency band) in band combination, e.g., the CGPA depends on a band combination (two bands using the same PA may use the same CGPA). For example, a band combination may include a first band and a second band, where SL RS transmitted in the first band is part of a first CGPA, and SL RS transmitted in the second band is part of a second CGPA (or may also be part of the first CGPA). In another example, a band combination may include a second band and a third band, where SL RS transmitted in the second band is part of a second CGPA, and SL RS transmitted in the third band is part of a third CGPA, etc.

In another example, the CGPA capabilities may be based on a band pair combination. For example, two SL RSs may be transmitted via a first band and a second band (e.g., one SL RS per band) that are associated with the same CGPA. This may also indicate that the SL RSs have the amplitude offset that is within X dB, the phase offset within Y degrees, the maximum time period within Z μs, etc.

In another example, the capabilities for CGPA may be transmitted based on the UE 1502 meeting a minimum specification for supporting the CGPA. For example, minimum specifications may be introduced for the first UE 1502 and/or the second UE 1504 to report capability of supporting the CGPA. Such specifications may be in the form of a maximum phase offset error, a maximum phase slope error, a maximum timing difference error, a maximum amplitude offset error, a minimum timing difference coherency, or a combination thereof.

At 1522, the first UE 1502 may transmit, to the second UE 1504 (or vice versa), an indication 1508 indicating an association between a set of RSs 1510, such as a set of SL RSs, and one or more CGPAs 1512 (e.g., based on the indication 1506). The association may map each of the set of RSs 1510 to one of the one or more CGPAs 1512. Each of the one or more CGPAs 1512 may be associated/assigned with a CG-ID, such that the first UE 1502 may indicate the association based on the CG-ID.

In some scenarios, some of the elements (e.g., transmission properties) of a CGPA may not be configurable, or reportable, but may be fixed. For example: if the first UE 1502 configures a coherent transmission of two SL RSs across two CCs, it may indicate that the amplitude offset is within X dB, the phase offset is within Y degrees, and/or the maximum time period within Z μs, etc.

At 1524, the UE 1502 may transmit, to the second UE 1504 (or vice versa), the set of RSs 1510 based on the association between the set of RSs 1510 and the one or more CGPAs 1512, and the second UE 1504 may also receive the set of RSs 1510 based on the association between the set of RSs 1510 and the one or more CGPAs 1512 to achieve coherent carrier aggregation for sidelink positioning (which may also be referred to as SL positioning aggregation).

At 1526, depending on who receives the set of RSs 1510, the first UE 1502 or the second UE 1504 may perform a set of positioning measurements 1514 for the set of RSs 1510 based on the association between the set of RSs 1510 and the one or more CGPAs 1512.

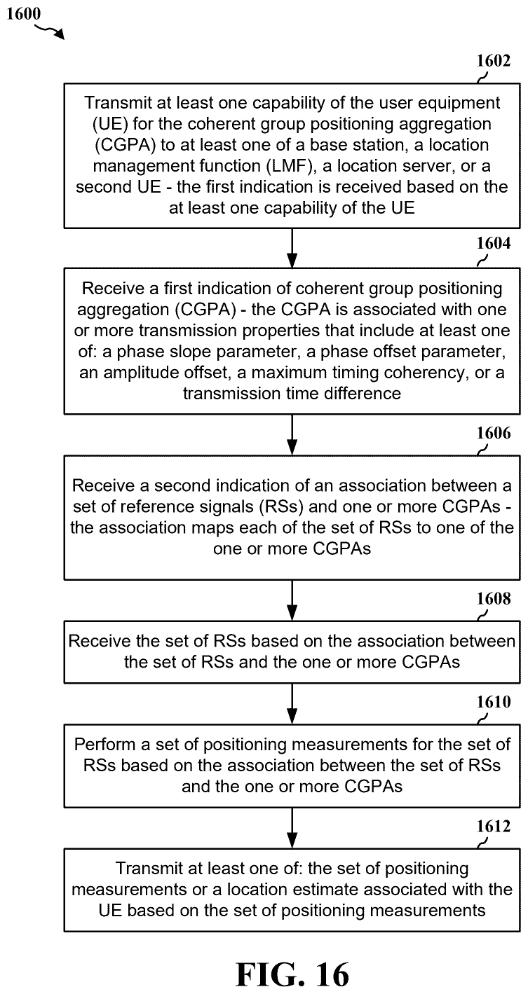

FIG. 16 is a flowchart 1600 of a method of wireless communication. The method may be performed by a UE (e.g., the UE 104, 404, 1302, 1402, 1502; the apparatus 1804). The method may enable the UE, during a DL/SL positioning, to receive indication of CGPA properties for a set of positioning reference signals (e.g., PRSs, SL RSs, etc.) from a base station or an LMF, such that the UE may receive the set of positioning reference signals based on coherent carrier aggregation.

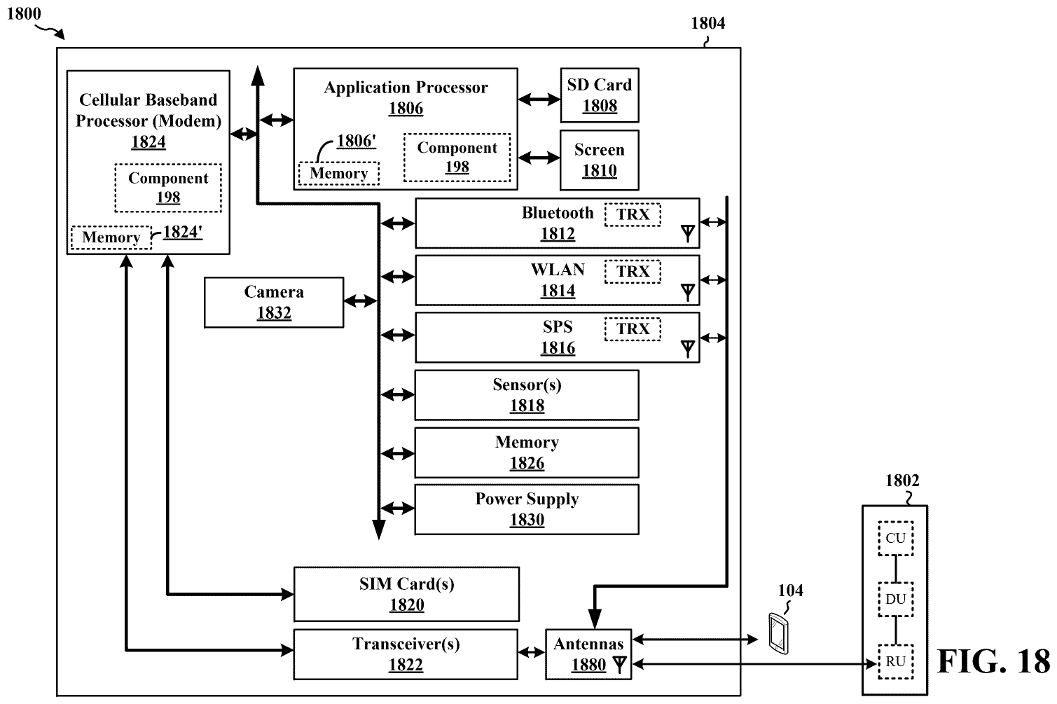

At 1602, the UE may transmit at least one capability of the UE for the CGPA to at least one of a base station, an LMF, a location server, or a second UE, where the first indication (e.g., received at 1604) may be received based on the at least one capability of the UE, such as described in connection with FIGS. 13 to 15. For example, at 1330 of FIG. 13, the UE 1302 may transmit its capability for CGPA to the base station 1304. The transmission of the at least one capability of the UE for the CGPA may be performed by, e.g., the CGPA indication and process component 198, the cellular baseband processor 1824, and/or the transceiver(s) 1822 of the apparatus 1804 in FIG. 18.

In one example, the at least one capability of the UE is transmitted in a band of at least one band combination, or the at least one capability of the UE is transmitted for each band pair combination of at least one band pair combination.

In another example, the at least one capability of the UE is transmitted based on the UE meeting a minimum specification for supporting the CGPA.

At 1604, the UE may receive a first indication of CGPA, where the CGPA may be associated with one or more transmission properties that include at least one of: a phase slope parameter, a phase offset parameter, an amplitude offset, a maximum timing coherency, or a transmission time difference, such as described in connection with FIGS. 11 to 15. For example, at 1320 of FIG. 13, the UE 1302 may receive an indication 1306 of CGPA from the base station 1304. The reception of the first indication of CGPA may be performed by, e.g., the CGPA indication and process component 198, the cellular baseband processor 1824, and/or the transceiver(s) 1822 of the apparatus 1804 in FIG. 18.

In one example, the one or more transmission properties further include a standard deviation of the at least one of: the phase slope parameter, the phase offset parameter, the amplitude offset, the maximum timing coherency, or the transmission time difference.

In another example, the amplitude offset or the phase offset parameter is frequency dependent or is valid for a defined frequency range.

At 1606, the UE may receive a second indication of an association between a set of RSs and one or more CGPAs, where the association may map each of the set of RSs to one of the one or more CGPAs, such as described in connection with FIGS. 13 to 15. For example, at 1322 of FIG. 13, the UE 1302 may receive an indication 1308 of an association between a set of RSs 1310 and one or more CGPAs 1312. The reception of the second indication of the association may be performed by, e.g., the CGPA indication and process component 198, the cellular baseband processor 1824, and/or the transceiver(s) 1822 of the apparatus 1804 in FIG. 18.

In one example, each CGPA of the one or more CGPAs is associated with a CG-ID.

In another example, each CGPA of the one or more CGPAs is associated with one or more PRS resources, one or more PRS resource sets, one or more PFLs, or a combination thereof.

In another example, the set of RSs corresponds to a plurality of BWPs for a same CC, multiple contiguous CCs, or non-contiguous CCs in a same band, or where the set of RSs corresponds to the plurality of BWPs for multiple CCs across different bands.

In another example, the set of RSs are DL PRSs, SL reference signals, or a combination thereof, and where the set of positioning measurements is associated with a UE-assisted positioning session or a UE-based positioning session.

At 1608, the UE may receive the set of RSs based on the association between the set of RSs and the one or more CGPAs, such as described in connection with FIGS. 13 to 15. For example, at 1324 of FIG. 13, the UE 1302 may receive the set of RSs 1310 based on the association. The reception of the set of RSs may be performed by, e.g., the CGPA indication and process component 198, the cellular baseband processor 1824, and/or the transceiver(s) 1822 of the apparatus 1804 in FIG. 18.

At 1610, the UE may perform a set of positioning measurements for the set of RSs based on the association between the set of RSs and the one or more CGPAs, such as described in connection with FIGS. 13 to 15. For example, at 1326 of FIG. 13, the UE 1302 may perform a set of positioning measurements 1314 for the set of RSs 1310 based on the association between the set of RSs 1310 and one or more CGPAs 1312. The set of positioning measurements may be performed by, e.g., the CGPA indication and process component 198, the cellular baseband processor 1824, and/or the transceiver(s) 1822 of the apparatus 1804 in FIG. 18.

At 1612, the UE may transmit at least one of: the set of positioning measurements or a location estimate associated with the UE based on the set of positioning measurements, such as described in connection with FIGS. 13 to 15. For example, at 1328 of FIG. 13, the UE 1302 may transmit the set of positioning measurements 1314 or a UE location estimate based on the set of positioning measurements 1314 to the base station 1304. The transmission of the positioning measurements or the location estimate may be performed by, e.g., the CGPA indication and process component 198, the cellular baseband processor 1824, and/or the transceiver(s) 1822 of the apparatus 1804 in FIG. 18.

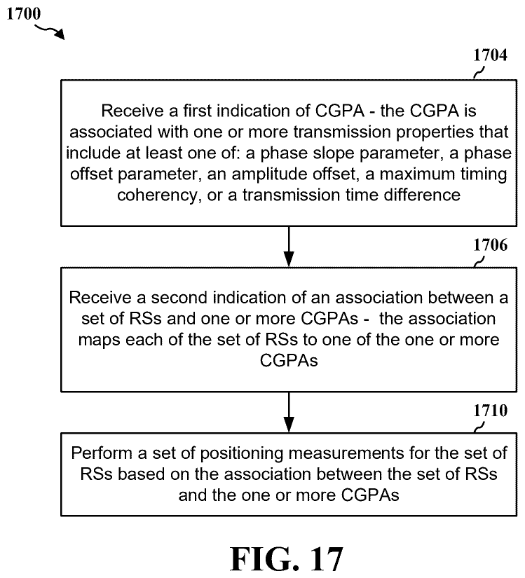

FIG. 17 is a flowchart 1700 of a method of wireless communication. The method may be performed by a UE (e.g., the UE 104, 404, 1302, 1402, 1502; the apparatus 1804). The method may enable the UE, during a DL/SL positioning, to receive indication of CGPA properties for a set of positioning reference signals (e.g., PRSs, SL RSs, etc.) from a base station or an LMF, such that the UE may receive the set of positioning reference signals based on coherent carrier aggregation.

At 1704, the UE may receive a first indication of CGPA, where the CGPA may be associated with one or more transmission properties that include at least one of: a phase slope parameter, a phase offset parameter, an amplitude offset, a maximum timing coherency, or a transmission time difference, such as described in connection with FIGS. 11 to 15. For example, at 1320 of FIG. 13, the UE 1302 may receive an indication 1306 of CGPA from the base station 1304. The reception of the first indication of CGPA may be performed by, e.g., the CGPA indication and process component 198, the cellular baseband processor 1824, and/or the transceiver(s) 1822 of the apparatus 1804 in FIG. 18.

In one example, the one or more transmission properties further include a standard deviation of the at least one of: the phase slope parameter, the phase offset parameter, the amplitude offset, the maximum timing coherency, or the transmission time difference.

In another example, the amplitude offset or the phase offset parameter is frequency dependent or is valid for a defined frequency range.

In another example, the UE may transmit at least one capability of the UE for the CGPA to at least one of a base station, an LMF, a location server, or a second UE, where the first indication may be received based on the at least one capability of the UE, such as described in connection with FIGS. 13 to 15. For example, at 1330 of FIG. 13, the UE 1302 may transmit its capability for CGPA to the base station 1304. The transmission of the at least one capability of the UE for the CGPA may be performed by, e.g., the CGPA indication and process component 198, the cellular baseband processor 1824, and/or the transceiver(s) 1822 of the apparatus 1804 in FIG. 18. In one example, the at least one capability of the UE is transmitted in a band of at least one band combination, or the at least one capability of the UE is transmitted for each band pair combination of at least one band pair combination. In another example, the at least one capability of the UE is transmitted based on the UE meeting a minimum specification for supporting the CGPA.

At 1706, the UE may receive a second indication of an association between a set of RSs and one or more CGPAs, where the association may map each of the set of RSs to one of the one or more CGPAs, such as described in connection with FIGS. 13 to 15. For example, at 1322 of FIG. 13, the UE 1302 may receive an indication 1308 of an association between a set of RSs 1310 and one or more CGPAs 1312. The reception of the second indication of the association may be performed by, e.g., the CGPA indication and process component 198, the cellular baseband processor 1824, and/or the transceiver(s) 1822 of the apparatus 1804 in FIG. 18.

In one example, each CGPA of the one or more CGPAs is associated with a CG-ID.

In another example, each CGPA of the one or more CGPAs is associated with one or more PRS resources, one or more PRS resource sets, one or more PFLs, or a combination thereof.

In another example, the set of RSs corresponds to a plurality of BWPs for a same CC, multiple contiguous CCs, or non-contiguous CCs in a same band, or where the set of RSs corresponds to the plurality of BWPs for multiple CCs across different bands.

In another example, the set of RSs are DL PRSs, SL reference signals, or a combination thereof, and where the set of positioning measurements is associated with a UE-assisted positioning session or a UE-based positioning session.

In another example, the UE may receive the set of RSs based on the association between the set of RSs and the one or more CGPAs, such as described in connection with FIGS. 13 to 15. For example, at 1324 of FIG. 13, the UE 1302 may receive the set of RSs 1310 based on the association. The reception of the set of RSs may be performed by, e.g., the CGPA indication and process component 198, the cellular baseband processor 1824, and/or the transceiver(s) 1822 of the apparatus 1804 in FIG. 18.

At 1710, the UE may perform a set of positioning measurements for the set of RSs based on the association between the set of RSs and the one or more CGPAs, such as described in connection with FIGS. 13 to 15. For example, at 1326 of FIG. 13, the UE 1302 may perform a set of positioning measurements 1314 for the set of RSs 1310 based on the association between the set of RSs 1310 and one or more CGPAs 1312.

The set of positioning measurements may be performed by, e.g., the CGPA indication and process component 198, the cellular baseband processor 1824, and/or the transceiver(s) 1822 of the apparatus 1804 in FIG. 18.

In one example, the UE may transmit at least one of: the set of positioning measurements or a location estimate associated with the UE based on the set of positioning measurements, such as described in connection with FIGS. 13 to 15. For example, at 1328 of FIG. 13, the UE 1302 may transmit the set of positioning measurements 1314 or a UE location estimate based on the set of positioning measurements 1314 to the base station 1304. The transmission of the positioning measurements or the location estimate may be performed by, e.g., the CGPA indication and process component 198, the cellular baseband processor 1824, and/or the transceiver(s) 1822 of the apparatus 1804 in FIG. 18.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial management unit (IMU), gyroscope, and/or accelerometer(s), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see 350 of FIG. 3) and include the additional modules of the apparatus 1804.

As discussed supra, the CGPA indication and process component 198 may be configured to receive a first indication of CGPA, where the CGPA is associated with one or more transmission properties that include at least one of: a phase slope parameter, a phase offset parameter, an amplitude offset, a maximum timing coherency, or a transmission time difference. The CGPA indication and process component 198 may also be configured to receive a second indication of an association between a set of RSs and one or more CGPAs, where the association maps each of the set of RSs to one of the one or more CGPAs. The CGPA indication and process component 198 may also be configured to perform a set of positioning measurements for the set of RSs based on the association between the set of RSs and the one or more CGPAs. The CGPA indication and process component 198 may be within the cellular baseband processor 1824, the application processor 1806, or both the cellular baseband processor 1824 and the application processor 1806. The CGPA indication and process component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, may include means for receiving a first indication of CGPA, where the CGPA is associated with one or more transmission properties that include at least one of: a phase slope parameter, a phase offset parameter, an amplitude offset, a maximum timing coherency, or a transmission time difference. The apparatus 1804 may further include means for receiving a second indication of an association between a set of RSs and one or more CGPAs, where the association maps each of the set of RSs to one of the one or more CGPAs. The apparatus 1804 may further include means for performing a set of positioning measurements for the set of RSs based on the association between the set of RSs and the one or more CGPAs.

In one configuration, the apparatus 1804 may further include means for receiving the set of RSs based on the association between the set of RSs and the one or more CGPAs.

In another configuration, the apparatus 1804 may further include means for transmitting at least one of: the set of positioning measurements or a location estimate associated with the UE based on the set of positioning measurements.

In another configuration, each CGPA of the one or more CGPAs is associated with a CG-ID.

In another configuration, each CGPA of the one or more CGPAs is associated with one or more PRS resources, one or more PRS resource sets, one or more PFLs, or a combination thereof.

In another configuration, the one or more transmission properties further include a standard deviation of the at least one of: the phase slope parameter, the phase offset parameter, the amplitude offset, the maximum timing coherency, or the transmission time difference.

In another configuration, the amplitude offset or the phase offset parameter is frequency dependent or is valid for a defined frequency range.

In another configuration, the set of RSs corresponds to a plurality of BWPs for a same CC, multiple contiguous CCs, or non-contiguous CCs in a same band, or where the set of RSs corresponds to the plurality of BWPs for multiple CCs across different bands.

In another configuration, the apparatus 1804 may further include means for transmitting at least one capability of the UE for the CGPA to at least one of a base station, an LMF, a location server, or a second UE, where the first indication is received based on the at least one capability of the UE. In such a configuration, the at least one capability of the UE is transmitted in a band of at least one band combination, or where the at least one capability of the UE is transmitted for each band pair combination of at least one band pair combination. In such a configuration, the at least one capability of the UE is transmitted based on the UE meeting a minimum specification for supporting the CGPA.

The means may be the CGPA indication and process component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

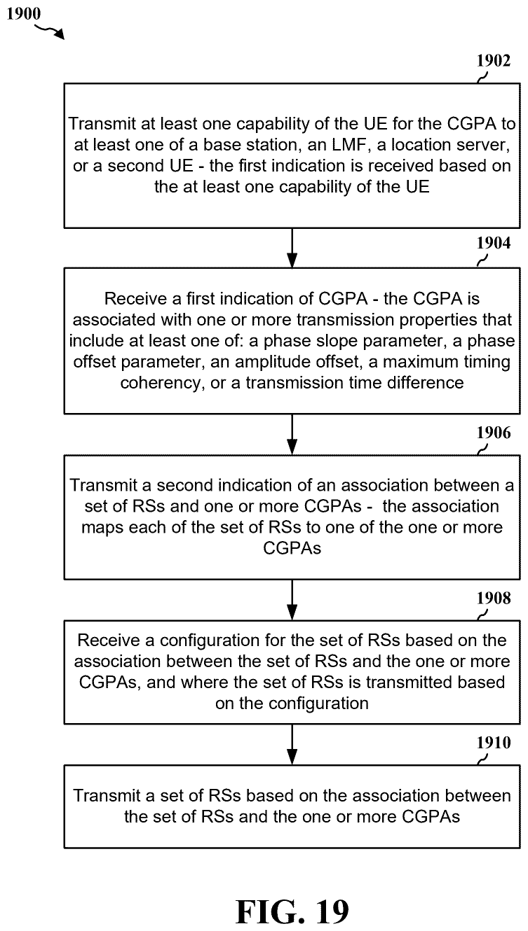

FIG. 19 is a flowchart 1900 of a method of wireless communication. The method may be performed by a UE (e.g., the UE 104, 404, 1302, 1402, 1502; the apparatus 2104). The method may enable the UE, during a UL/SL positioning, to indicate CGPA related capabilities to a base station or an LMF, and/or to receive/transmit indication of CGPA properties for a set of positioning reference signals (e.g., SRSs, SL RSs, etc.) from/to the base station or the LMF, such that the UE may transmit the set of positioning reference signals based on coherent carrier aggregation.

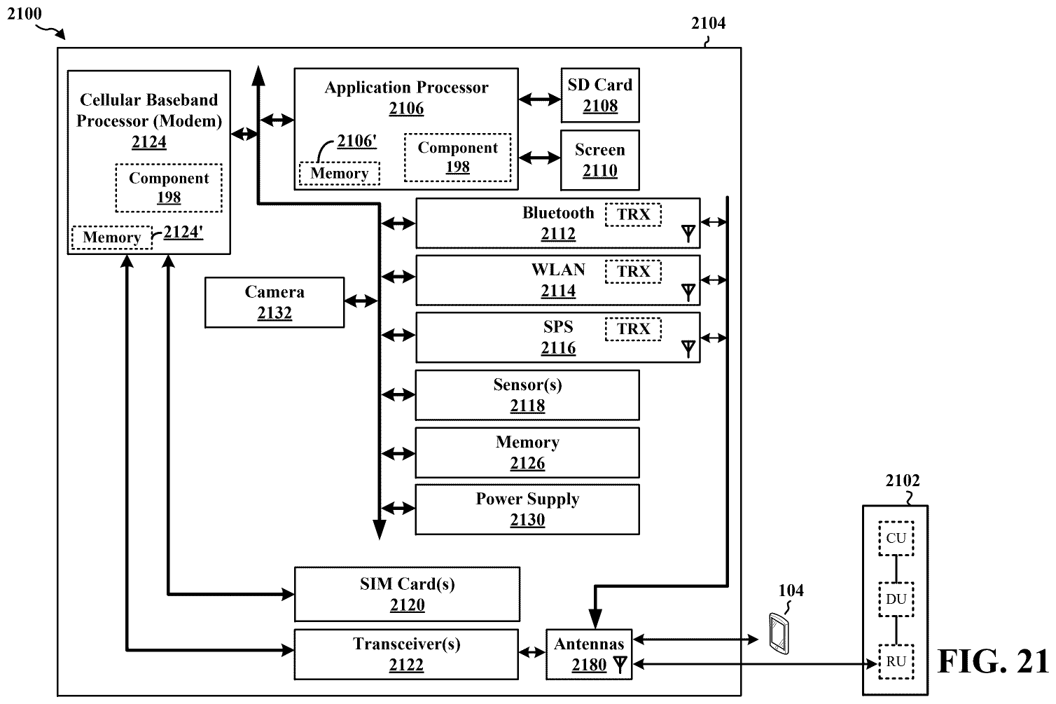

At 1902, the UE may transmit at least one capability of the UE for the CGPA to at least one of a base station, an LMF, a location server, or a second UE, where the first indication (e.g., received at 1904) may be received based on the at least one capability of the UE, such as described in connection with FIGS. 13 to 15. For example, at 1430 of FIG. 14, the UE 1402 may transmit its capability for CGPA to the base station 1404. The transmission of the at least one capability of the UE for the CGPA may be performed by, e.g., the CGPA indication and process component 198, the cellular baseband processor 2124, and/or the transceiver(s) 2122 of the apparatus 2104 in FIG. 21.

In one example, the at least one capability of the UE is transmitted in a band of at least one band combination, or the at least one capability of the UE is transmitted for each band pair combination of at least one band pair combination.

In another example, the at least one capability of the UE is transmitted based on the UE meeting a minimum specification for supporting the CGPA.

At 1904, the UE may receive a first indication of CGPA, where the CGPA may be associated with one or more transmission properties that include at least one of: a phase slope parameter, a phase offset parameter, an amplitude offset, a maximum timing coherency, or a transmission time difference, such as described in connection with FIGS. 11 to 15. For example, at 1420 of FIG. 14, the UE 1402 may receive/transmit an indication 1406 of CGPA from/to the base station 1404. The reception of the first indication of CGPA may be performed by, e.g., the CGPA indication and process component 198, the cellular baseband processor 2124, and/or the transceiver(s) 2122 of the apparatus 2104 in FIG. 21.

In one example, the one or more transmission properties further include a standard deviation of the at least one of: the phase slope parameter, the phase offset parameter, the amplitude offset, the maximum timing coherency, or the transmission time difference.

In another example, the amplitude offset or the phase offset parameter is frequency dependent or is valid for a defined frequency range.

At 1906, the UE may transmit a second indication of an association between a set of RSs and one or more CGPAs, where the association maps each of the set of RSs to one of the one or more CGPAs, such as described in connection with FIGS. 13 to 15. For example, at 1422 of FIG. 14, the UE 1402 may transmit an indication 1408 of an association between a set of RSs 1410 and one or more CGPAs 1412. The transmission of the second indication of the association may be performed by, e.g., the CGPA indication and process component 198, the cellular baseband processor 2124, and/or the transceiver(s) 2122 of the apparatus 2104 in FIG. 21.

In one example, each CGPA of the one or more CGPAs is associated with a CG-ID.

In another example, each CGPA of the one or more CGPAs is associated with one or more PRS resources, one or more PRS resource sets, one or more PFLs, or a combination thereof.

In another example, the set of RSs corresponds to a plurality of BWPs for a same CC, multiple contiguous CCs, or non-contiguous CCs in a same band, or where the set of RSs corresponds to the plurality of BWPs for multiple CCs across different bands.

In another example, the set of RSs are UL SRSs, SL reference signals, or a combination thereof, and where the set of RSs is transmitted for a UE-assisted positioning session.

At 1908, the UE may receive a configuration for the set of RSs based on the association between the set of RSs and the one or more CGPAs, and where the set of RSs is transmitted based on the configuration, such as described in connection with FIGS. 13 to 15. For example, at 1428 of FIG. 14, the UE 1402 may receive a configuration for the set of RSs 1410 from the base station 1404. The reception of the configuration may be performed by, e.g., the CGPA indication and process component 198, the cellular baseband processor 2124, and/or the transceiver(s) 2122 of the apparatus 2104 in FIG. 21.

At 1910, the UE may transmit a set of RSs based on the association between the set of RSs and the one or more CGPAs, such as described in connection with FIGS. 13 to 15. For example, at 1424 of FIG. 14, the UE 1402 may transmit the set of RSs 1410 based on the association. The transmission of the set of RSs may be performed by, e.g., the CGPA indication and process component 198, the cellular baseband processor 2124, and/or the transceiver(s) 2122 of the apparatus 2104 in FIG. 21.

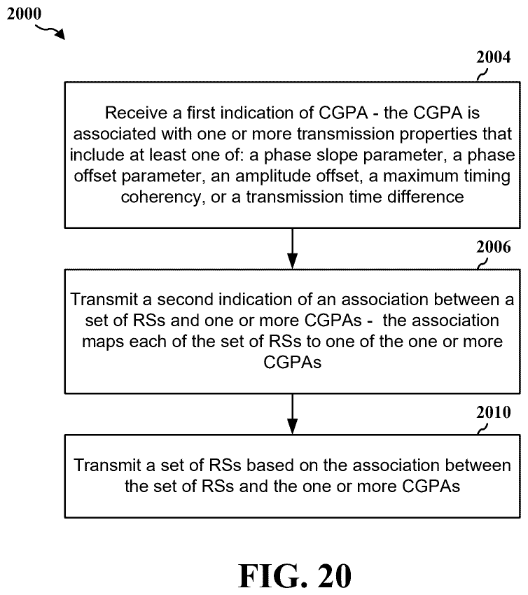

FIG. 20 is a flowchart 2000 of a method of wireless communication. The method may be performed by a UE (e.g., the UE 104, 404, 1302, 1402, 1502; the apparatus 2104). The method may enable the UE, during a UL/SL positioning, to indicate CGPA related capabilities to a base station or an LMF, and/or to receive/transmit indication of CGPA properties for a set of positioning reference signals (e.g., SRSs, SL RSs, etc.) from/to the base station or the LMF, such that the UE may transmit the set of positioning reference signals based on coherent carrier aggregation.

At 2004, the UE may receive a first indication of CGPA, where the CGPA may be associated with one or more transmission properties that include at least one of: a phase slope parameter, a phase offset parameter, an amplitude offset, a maximum timing coherency, or a transmission time difference, such as described in connection with FIGS. 11 to 15. For example, at 1420 of FIG. 14, the UE 1402 may receive/transmit an indication 1406 of CGPA from/to the base station 1404. The reception of the first indication of CGPA may be performed by, e.g., the CGPA indication and process component 198, the cellular baseband processor 2124, and/or the transceiver(s) 2122 of the apparatus 2104 in FIG. 21.

In one example, the one or more transmission properties further include a standard deviation of the at least one of: the phase slope parameter, the phase offset parameter, the amplitude offset, the maximum timing coherency, or the transmission time difference.

In another example, the amplitude offset or the phase offset parameter is frequency dependent or is valid for a defined frequency range.

In another example, the UE may transmit at least one capability of the UE for the CGPA to at least one of a base station, an LMF, a location server, or a second UE, where the first indication (e.g., received at 1904) may be received based on the at least one capability of the UE, such as described in connection with FIGS. 13 to 15. For example, at 1430 of FIG. 14, the UE 1402 may transmit its capability for CGPA to the base station 1404. The transmission of the at least one capability of the UE for the CGPA may be performed by, e.g., the CGPA indication and process component 198, the cellular baseband processor 2124, and/or the transceiver(s) 2122 of the apparatus 2104 in FIG. 21. In such an example, the at least one capability of the UE is transmitted in a band of at least one band combination, or the at least one capability of the UE is transmitted for each band pair combination of at least one band pair combination. In such an example, the at least one capability of the UE is transmitted based on the UE meeting a minimum specification for supporting the CGPA.

At 2006, the UE may transmit a second indication of an association between a set of RSs and one or more CGPAs, where the association maps each of the set of RSs to one of the one or more CGPAs, such as described in connection with FIGS. 13 to 15. For example, at 1422 of FIG. 14, the UE 1402 may transmit an indication 1408 of an association between a set of RSs 1410 and one or more CGPAs 1412. The transmission of the second indication of the association may be performed by, e.g., the CGPA indication and process component 198, the cellular baseband processor 2124, and/or the transceiver(s) 2122 of the apparatus 2104 in FIG. 21.

In one example, each CGPA of the one or more CGPAs is associated with a CG-ID.

In another example, each CGPA of the one or more CGPAs is associated with one or more PRS resources, one or more PRS resource sets, one or more PFLs, or a combination thereof.

In another example, the set of RSs corresponds to a plurality of BWPs for a same CC, multiple contiguous CCs, or non-contiguous CCs in a same band, or where the set of RSs corresponds to the plurality of BWPs for multiple CCs across different bands.

In another example, the set of RSs are UL SRSs, SL reference signals, or a combination thereof, and where the set of RSs is transmitted for a UE-assisted positioning session.

At 2010, the UE may transmit a set of RSs based on the association between the set of RSs and the one or more CGPAs, such as described in connection with FIGS. 13 to 15. For example, at 1424 of FIG. 14, the UE 1402 may transmit the set of RSs 1410 based on the association. The transmission of the set of RSs may be performed by, e.g., the CGPA indication and process component 198, the cellular baseband processor 2124, and/or the transceiver(s) 2122 of the apparatus 2104 in FIG. 21.

In one example, the UE may receive a configuration for the set of RSs based on the association between the set of RSs and the one or more CGPAs, and where the set of RSs is transmitted based on the configuration, such as described in connection with FIGS. 13 to 15. For example, at 1428 of FIG. 14, the UE 1402 may receive a configuration for the set of RSs 1410 from the base station 1404. The reception of the configuration may be performed by, e.g., the CGPA indication and process component 198, the cellular baseband processor 2124, and/or the transceiver(s) 2122 of the apparatus 2104 in FIG. 21.

FIG. 21 is a diagram 2100 illustrating an example of a hardware implementation for an apparatus 2104. The apparatus 2104 may be a UE, a component of a UE, or may implement UE functionality. In some aspects, the apparatus 2104 may include a cellular baseband processor 2124 (also referred to as a modem) coupled to one or more transceivers 2122 (e.g., cellular RF transceiver). The cellular baseband processor 2124 may include on-chip memory 2124′. In some aspects, the apparatus 2104 may further include one or more subscriber identity modules (SIM) cards 2120 and an application processor 2106 coupled to a secure digital (SD) card 2108 and a screen 2110. The application processor 2106 may include on-chip memory 2106′. In some aspects, the apparatus 2104 may further include a Bluetooth module 2112, a WLAN module 2114, an SPS module 2116 (e.g., GNSS module), one or more sensor modules 2118 (e.g., barometric pressure sensor/altimeter; motion sensor such as inertial management unit (IMU), gyroscope, and/or accelerometer(s), magnetometer, audio and/or other technologies used for positioning), additional memory modules 2126, a power supply 2130, and/or a camera 2132. The Bluetooth module 2112, the WLAN module 2114, and the SPS module 2116 may include an on-chip transceiver (TRX) (or in some cases, just a receiver (RX)). The Bluetooth module 2112, the WLAN module 2114, and the SPS module 2116 may include their own dedicated antennas and/or utilize the antennas 2180 for communication. The cellular baseband processor 2124 communicates through the transceiver(s) 2122 via one or more antennas 2180 with the UE 104 and/or with an RU associated with a network entity 2102. The cellular baseband processor 2124 and the application processor 2106 may each include a computer-readable medium/memory 2124′, 2106′, respectively. The additional memory modules 2126 may also be considered a computer-readable medium/memory. Each computer-readable medium/memory 2124′, 2106′, 2126 may be non-transitory. The cellular baseband processor 2124 and the application processor 2106 are each responsible for general processing, including the execution of software stored on the computer-readable medium/memory. The software, when executed by the cellular baseband processor 2124/application processor 2106, causes the cellular baseband processor 2124/application processor 2106 to perform the various functions described supra. The computer-readable medium/memory may also be used for storing data that is manipulated by the cellular baseband processor 2124/application processor 2106 when executing software. The cellular baseband processor 2124/application processor 2106 may be a component of the UE 350 and may include the memory 360 and/or at least one of the TX processor 368, the RX processor 356, and the controller/processor 359. In one configuration, the apparatus 2104 may be a processor chip (modem and/or application) and include just the cellular baseband processor 2124 and/or the application processor 2106, and in another configuration, the apparatus 2104 may be the entire UE (e.g., see 350 of FIG. 3) and include the additional modules of the apparatus 2104.

As discussed supra, the CGPA indication and process component 198 may be configured to receive a first indication of CGPA, where the CGPA is associated with one or more transmission properties that include at least one of: a phase slope parameter, a phase offset parameter, an amplitude offset, a maximum timing coherency, or a transmission time difference. The CGPA indication and process component 198 may also be configured to transmit a second indication of an association between a set of RSs and one or more CGPAs, where the association maps each of the set of RSs to one of the one or more CGPAs. The CGPA indication and process component 198 may also be configured to transmit a set of RSs based on the association between the set of RSs and the one or more CGPAs. The CGPA indication and process component 198 may be within the cellular baseband processor 2124, the application processor 2106, or both the cellular baseband processor 2124 and the application processor 2106. The CGPA indication and process component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2104 may include a variety of components configured for various functions. In one configuration, the apparatus 2104, and in particular the cellular baseband processor 2124 and/or the application processor 2106, may include means for receiving a first indication of CGPA, where the CGPA is associated with one or more transmission properties that include at least one of: a phase slope parameter, a phase offset parameter, an amplitude offset, a maximum timing coherency, or a transmission time difference. The apparatus 2104 may further include means for transmitting a second indication of an association between a set of RSs and one or more CGPAs, where the association maps each of the set of RSs to one of the one or more CGPAs. The apparatus 2104 may further include means for transmitting a set of RSs based on the association between the set of RSs and the one or more CGPAs.

In one configuration, the apparatus 2104 may further include means for receiving a configuration for the set of RSs based on the association between the set of RSs and the one or more CGPAs, and where the set of RSs is transmitted based on the configuration.

In another configuration, each CGPA of the one or more CGPAs is associated with a CG-ID.

In another configuration, each CGPA of the one or more CGPAs is associated with one or more PRS resources, one or more PRS resource sets, one or more PFLs, or a combination thereof.

In another configuration, the one or more transmission properties further include a standard deviation of the at least one of: the phase slope parameter, the phase offset parameter, the amplitude offset, the maximum timing coherency, or the transmission time difference.

In another configuration, the amplitude offset or the phase offset parameter is frequency dependent or is valid for a defined frequency range.

In another configuration, the set of RSs corresponds to a plurality of BWPs for a same CC, multiple contiguous CCs, or non-contiguous CCs in a same band, or where the set of RSs corresponds to the plurality of BWPs for multiple CCs across different bands.

In another configuration, the apparatus 2104 may further include means for transmitting at least one capability of the UE for the CGPA to at least one of a base station, an LMF, a location server, or a second UE, where the first indication is received based on the at least one capability of the UE. In such a configuration, the at least one capability of the UE is transmitted in a band of at least one band combination, or where the at least one capability of the UE is transmitted for each band pair combination of at least one band pair combination. In such a configuration, the at least one capability of the UE is transmitted based on the UE meeting a minimum specification for supporting the CGPA.

In another configuration, the set of RSs are UL SRSs, SL reference signals, or a combination thereof, and where the set of RSs is transmitted for a UE-assisted positioning session.

The means may be the CGPA indication and process component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

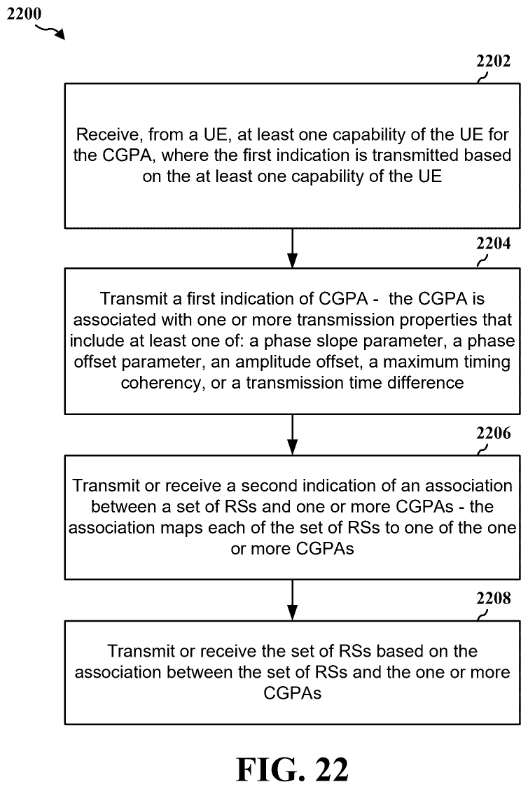

FIG. 22 is a flowchart 2200 of a method of wireless communication. The method may be performed by a base station (e.g., the base station 102, 1304, 1404; the network entity 2402. The method may enable the base station to perform coherent carrier aggregation for UL, DL, and SL positioning.

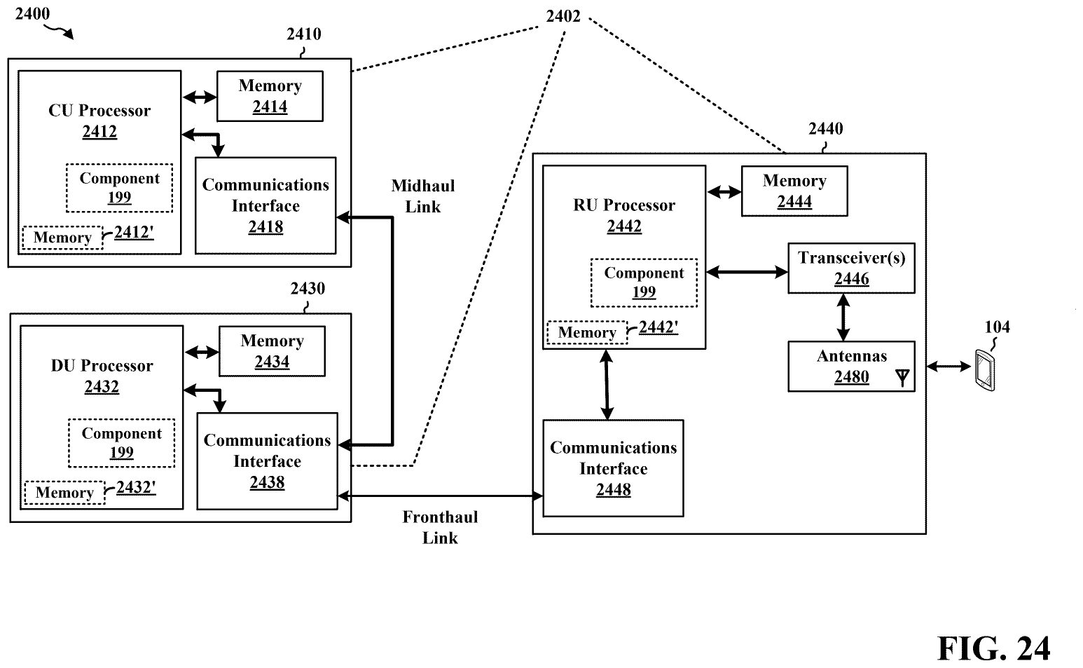

At 2202, the base station may receive, from a UE, at least one capability of the UE for the CGPA where the first indication (e.g., transmitted at 2204) may be transmitted based on the at least one capability of the UE, such as described in connection with FIGS. 13 to 14. For example, at 1330 of FIG. 13, the base station 1304 may receive capability for CGPA from the UE 1302. The reception of the at least one capability of the UE for the CGPA may be performed by, e.g., the CGPA indication and process component 199 and/or the transceiver(s) 2446 of the network entity 2402 in FIG. 24.

In one example, the at least one capability of the UE is received in a band of at least one band combination, or where the at least one capability of the UE is received for each band pair combination of at least one band pair combination.

In another example, the at least one capability of the UE is received based on the network node meeting a minimum specification for supporting the CGPA.

At 2204, the base station may transmit a first indication of CGPA, where the CGPA may be associated with one or more transmission properties that include at least one of: a phase slope parameter, a phase offset parameter, an amplitude offset, a maximum timing coherency, or a transmission time difference, such as described in connection with FIGS. 11 to 14. For example, at 1320 of FIG. 13, the base station 1304 may transmit an indication 1306 of CGPA to the UE 1302. The transmission of the first indication of CGPA may be performed by, e.g., the CGPA indication and process component 199 and/or the transceiver(s) 2446 of the network entity 2402 in FIG. 24.

In one example, the one or more transmission properties further include a standard deviation of the at least one of: the phase slope parameter, the phase offset parameter, the amplitude offset, the maximum timing coherency, or the transmission time difference.

In another example, the amplitude offset or the phase offset parameter is frequency dependent or is valid for a defined frequency range.

At 2206, the base station may transmit or receive a second indication of an association between a set of RSs and one or more CGPAs, where the association may map each of the set of RSs to one of the one or more CGPAs, such as described in connection with FIGS. 13 to 15. For example, at 1322 of FIG. 13, the base station 1304 may transmit, to the UE 1302, an indication 1308 of an association between a set of RSs 1310 and one or more CGPAs 1312. The transmission/reception of the second indication of the association may be performed by, e.g., the CGPA indication and process component 199 and/or the transceiver(s) 2446 of the network entity 2402 in FIG. 24.

In one example, each CGPA of the one or more CGPAs is associated with a CG-ID.

In another example, each CGPA of the one or more CGPAs is associated with one or more PRS resources, one or more PRS resource sets, one or more PFLs, or a combination thereof.

In another example, the set of RSs corresponds to a plurality of BWPs for a same CC, multiple contiguous CCs, or non-contiguous CCs in a same band, or where the set of RSs corresponds to the plurality of BWPs for multiple CCs across different bands.

At 2208, the base station may transmit or receive the set of RSs based on the association between the set of RSs and the one or more CGPAs, such as described in connection with FIGS. 13 to 15. For example, at 1324 of FIG. 13, the base station 1304 may transmit, to the UE 1302, the set of RSs 1310 based on the association. The transmission/reception of the set of RSs may be performed by, e.g., the CGPA indication and process component 199 and/or the transceiver(s) 2446 of the network entity 2402 in FIG. 24.

In one example, the base station receives the set of RSs based on the association between the set of RSs and the one or more CGPAs, and the base station performs a set of positioning measurements for the set of RSs based on the association between the set of RSs and the one or more CGPAs. In such an example, the set of RSs are uplink UL SRSs, SL reference signals, or a combination thereof, and where the set of positioning measurements is associated with a UE-assisted positioning session.

In another example, the base station transmits the set of RSs based on the association between the set of RSs and the one or more CGPAs, and the base station receives at least one of: a set of positioning measurements for the set of RSs or a location estimate associated with a UE. In such an example, the set of RSs are DL PRSs, SL reference signals, or a combination thereof.

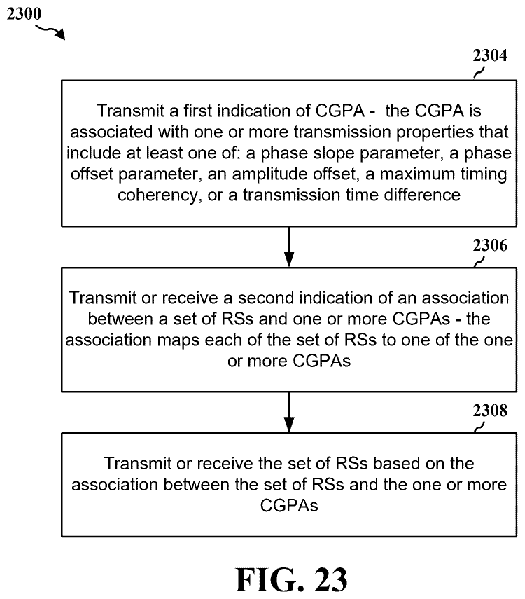

FIG. 23 is a flowchart 2300 of a method of wireless communication. The method may be performed by a base station (e.g., the base station 102, 1304, 1404; the network entity 2402. The method may enable the base station to perform coherent carrier aggregation for UL, DL, and SL positioning.

At 2304, the base station may transmit a first indication of CGPA, where the CGPA may be associated with one or more transmission properties that include at least one of: a phase slope parameter, a phase offset parameter, an amplitude offset, a maximum timing coherency, or a transmission time difference, such as described in connection with FIGS. 11 to 14. For example, at 1320 of FIG. 13, the base station 1304 may transmit an indication 1306 of CGPA to the UE 1302. The transmission of the first indication of CGPA may be performed by, e.g., the CGPA indication and process component 199 and/or the transceiver(s) 2446 of the network entity 2402 in FIG. 24.

In one example, the one or more transmission properties further include a standard deviation of the at least one of: the phase slope parameter, the phase offset parameter, the amplitude offset, the maximum timing coherency, or the transmission time difference.

In another example, the amplitude offset or the phase offset parameter is frequency dependent or is valid for a defined frequency range.

At 2306, the base station may transmit or receive a second indication of an association between a set of RSs and one or more CGPAs, where the association may map each of the set of RSs to one of the one or more CGPAs, such as described in connection with FIGS. 13 to 15. For example, at 1322 of FIG. 13, the base station 1304 may transmit, to the UE 1302, an indication 1308 of an association between a set of RSs 1310 and one or more CGPAs 1312. The transmission/reception of the second indication of the association may be performed by, e.g., the CGPA indication and process component 199 and/or the transceiver(s) 2446 of the network entity 2402 in FIG. 24.

In one example, each CGPA of the one or more CGPAs is associated with a CG-ID.

In another example, each CGPA of the one or more CGPAs is associated with one or more PRS resources, one or more PRS resource sets, one or more PFLs, or a combination thereof.

In another example, the set of RSs corresponds to a plurality of BWPs for a same CC, multiple contiguous CCs, or non-contiguous CCs in a same band, or where the set of RSs corresponds to the plurality of BWPs for multiple CCs across different bands.

At 2308, the base station may transmit or receive the set of RSs based on the association between the set of RSs and the one or more CGPAs, such as described in connection with FIGS. 13 to 15. For example, at 1324 of FIG. 13, the base station 1304 may transmit, to the UE 1302, the set of RSs 1310 based on the association. The transmission/reception of the set of RSs may be performed by, e.g., the CGPA indication and process component 199 and/or the transceiver(s) 2446 of the network entity 2402 in FIG. 24.

In one example, the base station receives the set of RSs based on the association between the set of RSs and the one or more CGPAs, and the base station performs a set of positioning measurements for the set of RSs based on the association between the set of RSs and the one or more CGPAs. In such an example, the set of RSs are uplink UL SRSs, SL reference signals, or a combination thereof, and where the set of positioning measurements is associated with a UE-assisted positioning session.

In another example, the base station transmits the set of RSs based on the association between the set of RSs and the one or more CGPAs, and the base station receives at least one of: a set of positioning measurements for the set of RSs or a location estimate associated with a UE. In such an example, the set of RSs are DL PRSs, SL reference signals, or a combination thereof.

In another example, the base station may receive, from a UE, at least one capability of the UE for the CGPA where the first indication (e.g., transmitted at 2204) may be transmitted based on the at least one capability of the UE, such as described in connection with FIGS. 13 to 14. For example, at 1330 of FIG. 13, the base station 1304 may receive capability for CGPA from the UE 1302. The reception of the at least one capability of the UE for the CGPA may be performed by, e.g., the CGPA indication and process component 199 and/or the transceiver(s) 2446 of the network entity 2402 in FIG. 24. In one example, the at least one capability of the UE is received in a band of at least one band combination, or where the at least one capability of the UE is received for each band pair combination of at least one band pair combination. In another example, the at least one capability of the UE is received based on the network node meeting a minimum specification for supporting the CGPA.

FIG. 24 is a diagram 2400 illustrating an example of a hardware implementation for a network entity 2402. The network entity 2402 may be a BS, a component of a BS, or may implement BS functionality. The network entity 2402 may include at least one of a CU 2410, a DU 2430, or an RU 2440. For example, depending on the layer functionality handled by the CGPA indication and process component 199, the network entity 2402 may include the CU 2410; both the CU 2410 and the DU 2430; each of the CU 2410, the DU 2430, and the RU 2440; the DU 2430; both the DU 2430 and the RU 2440; or the RU 2440. The CU 2410 may include a CU processor 2412. The CU processor 2412 may include on-chip memory 2412′. In some aspects, the CU 2410 may further include additional memory modules 2414 and a communications interface 2418. The CU 2410 communicates with the DU 2430 through a midhaul link, such as an F1 interface. The DU 2430 may include a DU processor 2432. The DU processor 2432 may include on-chip memory 2432′. In some aspects, the DU 2430 may further include additional memory modules 2434 and a communications interface 2438. The DU 2430 communicates with the RU 2440 through a fronthaul link. The RU 2440 may include an RU processor 2442. The RU processor 2442 may include on-chip memory 2442′. In some aspects, the RU 2440 may further include additional memory modules 2444, one or more transceivers 2446, antennas 2480, and a communications interface 2448. The RU 2440 communicates with the UE 104. The on-chip memory 2412′, 2432′, 2442′ and the additional memory modules 2414, 2434, 2444 may each be considered a computer-readable medium/memory. Each computer-readable medium/memory may be non-transitory. Each of the processors 2412, 2432, 2442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the CGPA indication and process component 199 may be configured to transmit a first indication of CGPA, where the CGPA is associated with one or more transmission properties that include at least one of: a phase slope parameter, a phase offset parameter, an amplitude offset, a maximum timing coherency, or a transmission time difference. The CGPA indication and process component 199 may also be configured to transmit or receive a second indication of an association between a set of RSs and one or more CGPAs, where the association maps each of the set of RSs to one of the one or more CGPAs. The CGPA indication and process component 199 may also be configured to transmit or receive the set of RSs based on the association between the set of RSs and the one or more CGPAs. The CGPA indication and process component 199 may be within one or more processors of one or more of the CU 2410, DU 2430, and the RU 2440. The CGPA indication and process component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2402 may include a variety of components configured for various functions. In one configuration, the network entity 2402 may include means for transmitting a first indication of CGPA, where the CGPA is associated with one or more transmission properties that include at least one of: a phase slope parameter, a phase offset parameter, an amplitude offset, a maximum timing coherency, or a transmission time difference. The network entity 2402 may further include means for transmitting or receiving a second indication of an association between a set of RSs and one or more CGPAs, where the association maps each of the set of RSs to one of the one or more CGPAs. The network entity 2402 may further include means for transmitting or receiving the set of RSs based on the association between the set of RSs and the one or more CGPAs.

In one configuration, the means for receiving the set of RSs based on the association between the set of RSs and the one or more CGPAs further includes configuring the network entity 2402 to perform a set of positioning measurements for the set of RSs based on the association between the set of RSs and the one or more CGPAs. In such a configuration, the set of RSs are UL SRSs, SL reference signals, or a combination thereof, and where the set of positioning measurements is associated with a UE-assisted positioning session.

In another configuration, the means for transmitting the set of RSs based on the association between the set of RSs and the one or more CGPAs further includes configuring the network entity 2402 to receive at least one of: a set of positioning measurements for the set of RSs or a location estimate associated with a UE. In such a configuration, the set of RSs are DL PRSs, SL reference signals, or a combination thereof.

In another configuration, each CGPA of the one or more CGPAs is associated with a CG-ID.

In another configuration, each CGPA of the one or more CGPAs is associated with one or more PRS resources, one or more PRS resource sets, one or more PFLs, or a combination thereof.

In another configuration, the one or more transmission properties further include a standard deviation of the at least one of: the phase slope parameter, the phase offset parameter, the amplitude offset, the maximum timing coherency, or the transmission time difference.

In another configuration, the amplitude offset or the phase offset parameter is frequency dependent or is valid for a defined frequency range.

In another configuration, the set of RSs corresponds to a plurality of BWPs for a same CC, multiple contiguous CCs, or non-contiguous CCs in a same band, or where the set of RSs corresponds to the plurality of BWPs for multiple CCs across different bands.

In another configuration, the network entity 2402 further includes means for receiving, from a UE, at least one capability of the UE for the CGPA, where the first indication is transmitted based on the at least one capability of the UE. In one example, the at least one capability of the UE is received in a band of at least one band combination, or where the at least one capability of the UE is received for each band pair combination of at least one band pair combination. In another example, the at least one capability of the UE is received based on the network node meeting a minimum specification for supporting the CGPA.

The means may be the CGPA indication and process component 199 of the network entity 2402 configured to perform the functions recited by the means. As described supra, the network entity 2402 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a first indication of CGPA, where the CGPA is associated with one or more transmission properties that include at least one of: a phase slope parameter, a phase offset parameter, an amplitude offset, a maximum timing coherency, or a transmission time difference; receiving a second indication of an association between a set of RSs and one or more CGs, where the association maps each of the set of RSs to one of the one or more CGs; and performing a set of positioning measurements for the set of RSs based on the association between the set of RSs and the one or more CGs.

Aspect 2 is the method of aspect 1, further including: receiving the set of RSs based on the association between the set of RSs and the one or more CGs.

Aspect 3 is the method of any of aspects 1 or 2, further including: transmitting at least one of: the set of positioning measurements or a location estimate associated with the UE based on the set of positioning measurements.

Aspect 4 is the method of any of aspects 1 to 3, where each CGPA of the one or more CGs is associated with a CG-ID.

Aspect 5 is the method of any of aspects 1 to 4, where each CGPA of the one or more CGs is associated with one or more PRS resources, one or more PRS resource sets, one or more PFLs, or a combination thereof.

Aspect 6 is the method of any of aspects 1 to 5, where the one or more transmission properties further include a standard deviation of the at least one of: the phase slope parameter, the phase offset parameter, the amplitude offset, the maximum timing coherency, or the transmission time difference.

Aspect 7 is the method of any of aspects 1 to 6, where the amplitude offset or the phase offset parameter is frequency dependent or is valid for a defined frequency range.

Aspect 8 is the method of any of aspects 1 to 7, where the set of RSs corresponds to a plurality of BWPs for a same CC, multiple contiguous CCs, or non-contiguous CCs in a same band, or where the set of RSs corresponds to the plurality of BWPs for multiple CCs across different bands.

Aspect 9 is the method of any of aspects 1 to 8, further including: transmitting at least one capability of the UE for the CGPA to at least one of a base station, an LMF, a location server, or a second UE, where the first indication is received based on the at least one capability of the UE.

Aspect 10 is the method of aspect 9, where the at least one capability of the UE is transmitted in a band of at least one band combination, or where the at least one capability of the UE is transmitted for each band pair combination of at least one band pair combination.

Aspect 11 is the method of aspect 9, where the at least one capability of the UE is transmitted based on the UE meeting a minimum specification for supporting the CGPA.

Aspect 12 is the method of aspect 11, where the set of RSs are DL PRSs, SL reference signals, or a combination thereof, and where the set of positioning measurements is associated with a UE-assisted positioning session or a UE-based positioning session.

Aspect 13 is an apparatus for wireless communication at a UE, including: a memory; and at least one processor coupled to the memory and, based at least in part on information stored in the memory, the at least one processor is configured to implement any of aspects 1 to 12.

Aspect 14 is the apparatus of aspect 13, further including at least one of a transceiver or an antenna coupled to the at least one processor.

Aspect 15 is an apparatus for wireless communication including means for implementing any of aspects 1 to 12.

Aspect 16 is a computer-readable medium (e.g., a non-transitory computer-readable medium) storing computer executable code, where the code when executed by a processor causes the processor to implement any of aspects 1 to 12.

Aspect 17 is a method of wireless communication at a UE, including: receiving a first indication of CGPA, where the CGPA is associated with one or more transmission properties that include at least one of: a phase slope parameter, a phase offset parameter, an amplitude offset, a maximum timing coherency, or a transmission time difference; transmitting a second indication of an association between a set of RSs and one or more CGs, where the association maps each of the set of RSs to one of the one or more CGs; and transmitting a set of RSs based on the association between the set of RSs and the one or more CGs.

Aspect 18 is the method of aspect 17, further including: receiving a configuration for the set of RSs based on the association between the set of RSs and the one or more CGs, and where the set of RSs is transmitted based on the configuration.

Aspect 19 is the method of any of aspects 17 or 18, where each CGPA of the one or more CGs is associated with a CG-ID.

Aspect 20 is the method of any of aspects 17 to 19, where each CGPA of the one or more CGs is associated with one or more PRS resources, one or more PRS resource sets, one or more PFLs, or a combination thereof.

Aspect 21 is the method of any of aspects 17 to 20, where the one or more transmission properties further include a standard deviation of the at least one of: the phase slope parameter, the phase offset parameter, the amplitude offset, the maximum timing coherency, or the transmission time difference.

Aspect 22 is the method of any of aspects 17 to 21, where the amplitude offset or the phase offset parameter is frequency dependent or is valid for a defined frequency range.

Aspect 23 is the method of any of aspects 17 to 22, where the set of RSs corresponds to a plurality of BWPs for a same CC, multiple contiguous CCs, or non-contiguous CCs in a same band, or where the set of RSs corresponds to the plurality of BWPs for multiple CCs across different bands.

Aspect 24 is the method of any of aspects 17 to 23, further including: transmitting at least one capability of the UE for the CGPA to at least one of a base station, an LMF, a location server, or a second UE, where the first indication is received based on the at least one capability of the UE.

Aspect 25 is the method of aspect 24, where the at least one capability of the UE is transmitted in a band of at least one band combination, or where the at least one capability of the UE is transmitted for each band pair combination of at least one band pair combination.

Aspect 26 is the method of aspect 24, where the at least one capability of the UE is transmitted based on the UE meeting a minimum specification for supporting the CGPA.

Aspect 27 is the method of any of aspects 17 to 26, where the set of RSs are uplink UL SRSs, SL reference signals, or a combination thereof, and where the set of RSs is transmitted for a UE-assisted positioning session.

Aspect 28 is an apparatus for wireless communication at a UE, including: a memory; and at least one processor coupled to the memory and, based at least in part on information stored in the memory, the at least one processor is configured to implement any of aspects 17 to 27.

Aspect 29 is the apparatus of aspect 28, further including at least one of a transceiver or an antenna coupled to the at least one processor.

Aspect 30 is an apparatus for wireless communication including means for implementing any of aspects 17 to 27.

Aspect 31 is a computer-readable medium (e.g., a non-transitory computer-readable medium) storing computer executable code, where the code when executed by a processor causes the processor to implement any of aspects 17 to 27.

Aspect 32 is a method of wireless communication at a network node, including: transmitting a first indication of CGPA, where the CGPA is associated with one or more transmission properties that include at least one of: a phase slope parameter, a phase offset parameter, an amplitude offset, a maximum timing coherency, or a transmission time difference; transmitting or receiving a second indication of an association between a set of RSs and one or more CGs, where the association maps each of the set of RSs to one of the one or more CGs; and transmitting or receiving the set of RSs based on the association between the set of RSs and the one or more CGs.

Aspect 33 is the method of aspect 32, further including: performing a set of positioning measurements for the set of RSs based on the association between the set of RSs and the one or more CGs.

Aspect 34 is the method of aspect 33, where the set of RSs are UL SRSs, SL reference signals, or a combination thereof, and where the set of positioning measurements is associated with a UE-assisted positioning session.

Aspect 35 is the method of any of aspects 32 to 34, further including: receiving at least one of: a set of positioning measurements for the set of RSs or a location estimate associated with a UE.

Aspect 36 is the method of aspect 35, where the set of RSs are DL PRSs, SL reference signals, or a combination thereof.

Aspect 37 is the method of any of aspects 32 to 36, where each CGPA of the one or more CGs is associated with a CG-ID.

Aspect 38 is the method of any of aspects 32 to 37, where each CGPA of the one or more CGs is associated with one or more PRS resources, one or more PRS resource sets, one or more PFLs, or a combination thereof.

Aspect 39 is the method of any of aspects 32 to 38, where the one or more transmission properties further include a standard deviation of the at least one of: the phase slope parameter, the phase offset parameter, the amplitude offset, the maximum timing coherency, or the transmission time difference.

Aspect 40 is the method of any of aspects 32 to 39, where the amplitude offset or the phase offset parameter is frequency dependent or is valid for a defined frequency range.

Aspect 41 is the method of any of aspects 32 to 40, where the set of RSs corresponds to a plurality of BWPs for a same CC, multiple contiguous CCs, or non-contiguous CCs in a same band, or where the set of RSs corresponds to the plurality of BWPs for multiple CCs across different bands.

Aspect 42 is the method of any of aspects 32 to 41, further including: receiving, from a UE, at least one capability of the UE for the CGPA, where the first indication is transmitted based on the at least one capability of the UE.

Aspect 43 is the method of aspect 42, where the at least one capability of the UE is received in a band of at least one band combination, or where the at least one capability of the UE is received for each band pair combination of at least one band pair combination.

Aspect 44 is the method of aspect 42, where the at least one capability of the UE is received based on the network node meeting a minimum specification for supporting the CGPA.

Aspect 45 is an apparatus for wireless communication at a UE, including: a memory; and at least one processor coupled to the memory and, based at least in part on information stored in the memory, the at least one processor is configured to implement any of aspects 32 to 44.

Aspect 46 is the apparatus of aspect 28, further including at least one of a transceiver or an antenna coupled to the at least one processor.

Aspect 47 is an apparatus for wireless communication including means for implementing any of aspects 32 to 44.

Aspect 48 is a computer-readable medium (e.g., a non-transitory computer-readable medium) storing computer executable code, where the code when executed by a processor causes the processor to implement any of aspects 32 to 44.

What is claimed is:

1. An apparatus for wireless communication at a user equipment (UE), comprising:
a memory; and
at least one processor coupled to the memory and, based at least in part on information stored in the memory, the at least one processor is configured to:
receive a first indication of coherent group positioning aggregation (CGPA), wherein the CGPA is associated with one or more transmission properties that include at least one of: a phase slope parameter, a phase offset parameter, an amplitude offset, a maximum timing coherency, or a transmission time difference;
receive a second indication of an association between a set of reference signals (RSs) and one or more CGPAs, wherein the association maps each of the set of RSs to one of the one or more CGPAs; and
perform a set of positioning measurements for the set of RSs based on the association between the set of RSs and the one or more CGPAs.

2. The apparatus of claim 1, wherein the at least one processor is configured to:
receive the set of RSs based on the association between the set of RSs and the one or more CGPAs.

3. The apparatus of claim 1, wherein the at least one processor is configured to:
transmit at least one of: the set of positioning measurements or a location estimate associated with the UE based on the set of positioning measurements.

4. The apparatus of claim 1, wherein each CGPA of the one or more CGPAs is associated with a CGPA identifier (ID).

5. The apparatus of claim 1, wherein each CGPA of the one or more CGPAs is associated with one or more positioning reference signal (PRS) resources, one or more PRS resource sets, one or more positioning frequency layers (PFLs), or a combination thereof.

6. The apparatus of claim 1, wherein the one or more transmission properties further include a standard deviation of the at least one of: the phase slope parameter, the phase offset parameter, the amplitude offset, the maximum timing coherency, or the transmission time difference.

7. The apparatus of claim 1, wherein the amplitude offset or the phase offset parameter is frequency dependent or is valid for a defined frequency range.

8. The apparatus of claim 1, wherein the set of RSs corresponds to a plurality of bandwidth parts (BWPs) for a same component carrier (CC), multiple contiguous CCs, or non-contiguous CCs in a same band, or wherein the set of RSs corresponds to the plurality of BWPs for multiple CCs across different bands.

9. The apparatus of claim 1, wherein the at least one processor is configured to:
transmit at least one capability of the UE for the CGPA to at least one of a base station, a location management function (LMF), a location server, or a second UE, wherein the first indication is received based on the at least one capability of the UE.

10. The apparatus of claim 9, wherein the at least one capability of the UE is transmitted in a band of at least one band combination, or wherein the at least one capability of the UE is transmitted for each band pair combination of at least one band pair combination.

11. The apparatus of claim 9, wherein the at least one capability of the UE is transmitted based on the UE meeting a minimum specification for supporting the CGPA.

12. The apparatus of claim 1, wherein the set of RSs are downlink (DL) positioning reference signals (PRSs), sidelink (SL) reference signals, or a combination thereof, and wherein the set of positioning measurements is associated with a UE-assisted positioning session or a UE-based positioning session.

13. A method of wireless communication at a user equipment (UE), comprising:
receiving a first indication of coherent group positioning aggregation (CGPA), wherein the CGPA is associated with one or more transmission properties that include at least one of: a phase slope parameter, a phase offset parameter, an amplitude offset, a maximum timing coherency, or a transmission time difference;
receiving a second indication of an association between a set of reference signals (RSs) and one or more CGPAs, wherein the association maps each of the set of RSs to one of the one or more CGPAs; and
performing a set of positioning measurements for the set of RSs based on the association between the set of RSs and the one or more CGPAs.

14. An apparatus for wireless communication at a user equipment (UE), comprising:
a memory; and
at least one processor coupled to the memory and, based at least in part on information stored in the memory, the at least one processor is configured to:
receive a first indication of coherent group positioning aggregation (CGPA), wherein the CGPA is associated with one or more transmission properties that include at least one of: a phase slope parameter, a phase offset parameter, an amplitude offset, a maximum timing coherency, or a transmission time difference;
transmit a second indication of an association between a set of reference signals (RSs) and one or more CGPAs, wherein the association maps each of the set of RSs to one of the one or more CGPAs; and
transmit a set of RSs based on the association between the set of RSs and the one or more CGPAs.

15. The apparatus of claim 14 wherein the at least one processor is configured to:
receive a configuration for the set of RSs based on the association between the set of RSs and the one or more CGPAs, and wherein the set of RSs is transmitted based on the configuration.

16. The apparatus of claim 14 wherein each CGPA of the one or more CGPAs is associated with a CG identifier (ID).

17. The apparatus of claim 14 wherein the one or more transmission properties further include a standard deviation of the at least one of: the phase slope parameter, the phase offset parameter, the amplitude offset, the maximum timing coherency, or the transmission time difference.

18. The apparatus of claim 14 wherein the amplitude offset or the phase offset parameter is frequency dependent or is valid for a defined frequency range.

19. The apparatus of claim 14 wherein the at least one processor is configured to:
transmit at least one capability of the UE for the CGPA to at least one of a base station, a location management function (LMF), a location server, or a second UE, wherein the first indication is received based on the at least one capability of the UE.

20. The apparatus of claim 19, wherein the at least one capability of the UE is transmitted in a band of at least one band combination, or wherein the at least one capability of the UE is transmitted for each band pair combination of at least one band pair combination.

21. The apparatus of claim 19, wherein the at least one capability of the UE is transmitted based on the UE meeting a minimum specification for supporting the CGPA.

22. The apparatus of claim 14 wherein the set of RSs are uplink (UL) sounding reference signals (SRSs), sidelink (SL) reference signals, or a combination thereof, and wherein the set of RSs is transmitted for a UE-assisted positioning session.

23. An apparatus for wireless communication at a network node, comprising:
a memory; and
at least one processor coupled to the memory and, based at least in part on information stored in the memory, the at least one processor is configured to:
transmit (or receive) a first indication of coherent group positioning aggregation (CGPA), wherein the CGPA is associated with one or more transmission properties that include at least one of: a phase slope parameter, a phase offset parameter, an amplitude offset, a maximum timing coherency, or a transmission time difference;
transmit or receive a second indication of an association between a set of reference signals (RSs) and one or CGPAs, wherein the association maps each of the set of RSs to one of the one or more CGPAs; and
transmit or receive the set of RSs based on the association between the set of RSs and the one or more CGPAs.

24. The apparatus of claim 23 wherein the network node receives the set of RSs based on the association between the set of RSs and the one or more CGPAs, and wherein the at least one processor is configured to:
perform a set of positioning measurements for the set of RSs based on the association between the set of RSs and the one or more CGPAs.

25. The apparatus of claim 23 wherein the network node transmits the set of RSs based on the association between the set of RSs and the one or more CGPAs, and wherein the at least one processor is configured to:
receive at least one of: a set of positioning measurements for the set of RSs or a location estimate associated with a user equipment (UE).

26. The apparatus of claim 23 wherein each CGPA of the one or more CGPAs is associated with a CG identifier (ID).

27. The apparatus of claim 23 wherein each CGPA of the one or more CGPAs is associated with one or more positioning reference signal (PRS) resources, one or more PRS resource sets, one or more positioning frequency layers (PFLs), or a combination thereof.

28. The apparatus of claim 23 wherein the one or more transmission properties further include a standard deviation of the at least one of: the phase slope parameter, the phase offset parameter, the amplitude offset, the maximum timing coherency, or the transmission time difference.

29. The apparatus of claim 23 wherein the set of RSs corresponds to a plurality of bandwidth parts (BWPs) for a same component carrier (CC), multiple contiguous CCs, or non-contiguous CCs in a same band, or wherein the set of RSs corresponds to the plurality of BWPs for multiple CCs across different bands.

30. The apparatus of claim 23 wherein the at least one processor is configured to:
receive, from a user equipment (UE), at least one capability of the UE for the CGPA, wherein the first indication is transmitted based on the at least one capability of the UE.
